(19) United States
(12) Patent Application Publication
(10) Pub. No.: US 2026/0243863 A1
(43) Pub. Date: Aug. 20, 2026

(54) TRACKING BASED ON SOUND AND SENSOR FUSION

(71) Applicant: QUALCOMM Incorporated, San Diego, CA (US)

(72) Inventor: Feliciano GOMEZ MARTINEZ, Los Gatos, CA (US)

(21) Appl. No.: 19/054,694

(22) Filed: Feb. 14, 2025

(51) Int. Cl. G01S 5/22

(52) U.S. Cl. CPC G01S 5/22

(57) ABSTRACT

Aspects presented herein may enable a first UE with multiple microphones to rely on measuring the time or phase difference between the sound captured by each microphone of the first user equipment (UE), and then using that information (in conjunction with the position/orientation of the first UE relative to a reference frame) to determine the direction in three dimensional (3D) space from which the sound is coming. In one aspect, a first UE measures, from a plurality of poses of the first UE, at least one of a set of phase delays or a set of time delays of sound from a second UE using at least two microphones of the first UE. The first UE estimates a relative location of the second UE based on the set of phase delays or the set of time delays and the plurality of poses of the first UE.

### TECHNICAL FIELD

The present disclosure relates generally to communication systems, and more particularly, to wireless communication involving positioning and tracking.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning (e.g., including tracking and/or ranging) protocols and techniques that enable mobile network operators to provide high-accuracy location/tracking/ranging services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus measures, from a plurality of poses of the first user equipment (UE), at least one of a set of phase delays or a set of time delays of sound from a second UE using at least two microphones of the first UE. The apparatus estimates a relative location of the second UE based on the set of phase delays or the set of time delays and the plurality of poses of the first UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5 is a diagram illustrating an example of tracking in accordance with various aspects of the present disclosure.

FIG. 6 is a diagram illustrating an example of a mobile device with multiple microphones in accordance with various aspects of the present disclosure.

FIG. 7 is a diagram illustrating an example angle of arrival (in two-dimension (2D)) for sound in accordance with various aspects of the present disclosure.

FIG. 8 is a diagram illustrating an example phase difference of arrival (in 2D) for sound in accordance with various aspects of the present disclosure.

FIG. 9A is a diagram illustrating an example relationship between sound wavelength and microphone separation in accordance with various aspects of the present disclosure.

FIG. 9B is a diagram illustrating an example relationship between sound wavelength and microphone separation in accordance with various aspects of the present disclosure.

FIG. 9C is a diagram illustrating an example relationship between sound wavelength and microphone separation in accordance with various aspects of the present disclosure.

FIG. 10A is a diagram illustrating an example relationship between sound wavelength and microphone separation in accordance with various aspects of the present disclosure.

FIG. 10B is a diagram illustrating an example relationship between sound wavelength and microphone separation in accordance with various aspects of the present disclosure.

FIG. 11 is a diagram illustrating an example of why some pure tones may be hard to pinpoint in accordance with various aspects of the present disclosure.

FIG. 12 is a diagram illustrating an example of estimating angle of arrival using phase difference of arrival (PDoA) or time delay in accordance with various aspects of the present disclosure.

FIG. 13A is a diagram illustrating an example of a collaborative case where a target device may be configured/requested to produce the sound using a sound frequency that is selected based on the microphone separation of the finder device in accordance with various aspects of the present disclosure.

FIG. 13B is a diagram illustrating an example of a collaborative case where a target device may be configured/requested to produce the sound using a sound frequency that is selected based on the microphone separation of the finder device in accordance with various aspects of the present disclosure.

FIG. 13C is a diagram illustrating an example of a collaborative case where a target device may be configured/requested to produce the sound using a sound frequency that is selected based on the microphone separation of the finder device in accordance with various aspects of the present disclosure.

FIG. 14 is a diagram illustrating an example of estimating angle of arrival in a three-dimensional (3D) space in accordance with various aspects of the present disclosure.

FIG. 15 is a diagram illustrating an example of a finder device tracking the angle-of-arrival (AoA) of sound and also its position/orientation simultaneously in accordance with various aspects of the present disclosure.

FIG. 16 is a diagram illustrating an example of a finder device estimating the position of a target device based on the poses of the finder device and the estimation of AoA between pairs of microphones in accordance with various aspects of the present disclosure.

FIG. 17 is a diagram illustrating an example user experience of a finder device locating a target device based on sound in accordance with various aspects of the present disclosure.

FIG. 18 is a diagram illustrating an example user experience of a finder device locating a target device based on sound in accordance with various aspects of the present disclosure.

FIG. 19 is a diagram illustrating an example of multiple devices continuously tracking their positions based on sound in accordance with various aspects of the present disclosure.

FIG. 20 is a flowchart of a method of wireless communication.

FIG. 21 is a flowchart of a method of wireless communication.

FIG. 22 is a diagram illustrating an example of a hardware implementation for an example apparatus and/or network entity.

### DETAILED DESCRIPTION

Various aspects relate generally to wireless communication and more particularly to tracking and/or ranging based on wireless communication. Some aspects more specifically relate to enable a wireless device with multiple microphones to rely on measuring the time or phase difference between the sound captured by each microphone of the wireless device, and then using that information (in conjunction with the position/orientation of the wireless device relative to a reference frame) to determine the direction in three-dimensional (3D) space from which the sound is coming. Then, the information is conveyed to the user with an appropriate graphical UI that shows the direction where the sound is coming from. Aspects presented herein may also support using ultrasounds (sound waves of higher frequency, which may not be heard by humans) to enable uses cases in which audible sounds may not be appropriate (e.g., not to disturb people with continuous beeping or for privacy concerns).

Particular aspects of the subject matter described in this disclosure can be implemented to realize one or more of the following potential advantages. While exiting tracking/ranging mechanisms may have a variety of applications in real life (e.g., enabling users to locate lost items that support some type of wireless ranging technology), often either the lost items or the smartphone may not support any of the modern radios that enables wireless ranging (e.g., some devices do not have ultra-wideband (UWB), Wi-Fi® and/or Bluetooth® capabilities). As most electronic devices may have the capability to produce sound (either audible, or ultrasonic), aspects presented herein provide various mechanisms that enable sound produced by electronic devices to be used for locating the electronic devices, thereby extending the applicability of tracking/ranging to more electronic devices and fields. Aspects presented herein may also enable a wireless device (e.g., a smartphone with multiple microphones) to automatically locate the position of a lost device/item using the relative delay of the sound captured by the microphones, in combination with position/orientation information of the wireless device obtained from inertial measurement unit (IMU) sensors and camera.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

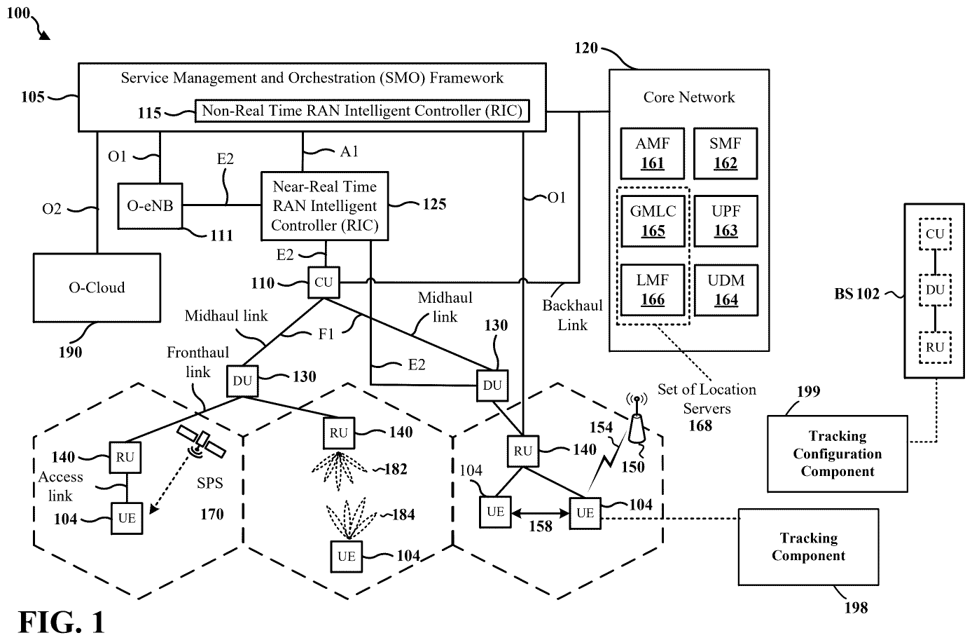

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a tracking component 198 that may be configured to measure, from a plurality of poses of the first UE, at least one of a set of phase delays or a set of time delays of sound from a second UE using at least two microphones of the first UE; and estimate a relative location of the second UE based on the set of phase delays or the set of time delays and the plurality of poses of the first UE. In certain aspects, the base station 102 may have a tracking configuration component 199 that may be configured to provide configurations and/or parameters related to tracking/ranging for the UE 104.

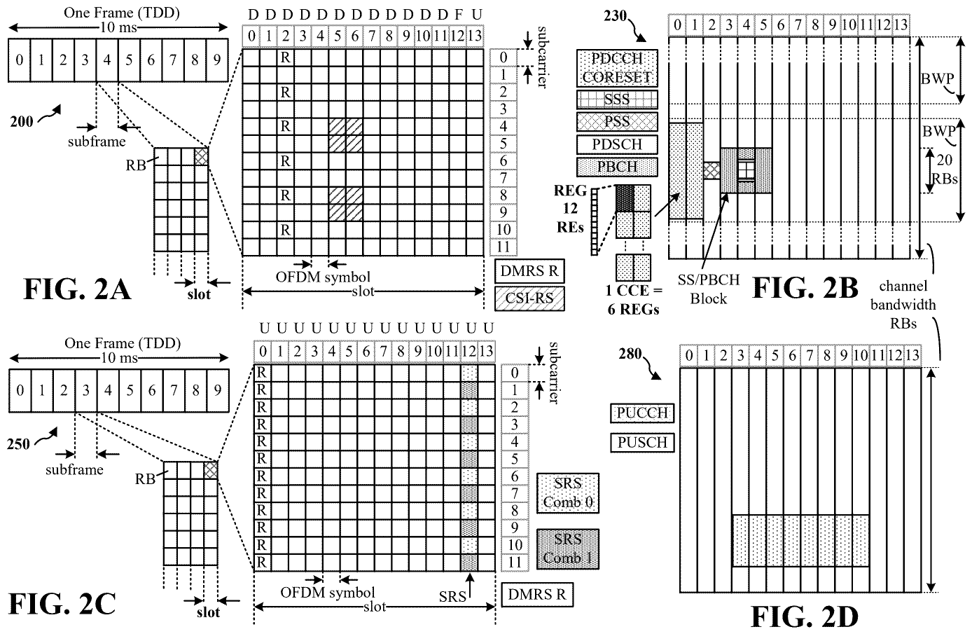

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

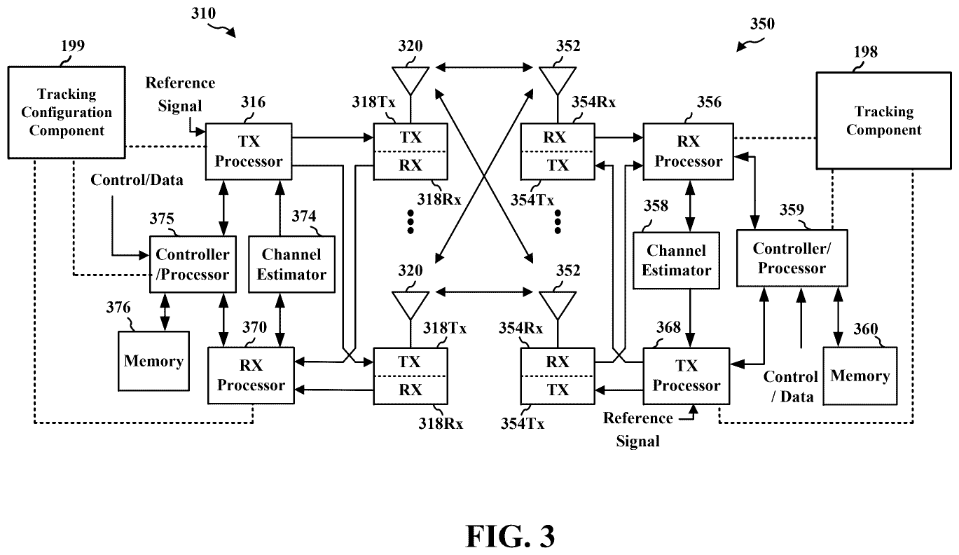

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the tracking component 198 of FIG. 1.

At least one of the TX processor 316, the RX processor 370, and the controller/processor 375 may be configured to perform aspects in connection with the tracking configuration component 199 of FIG. 1.

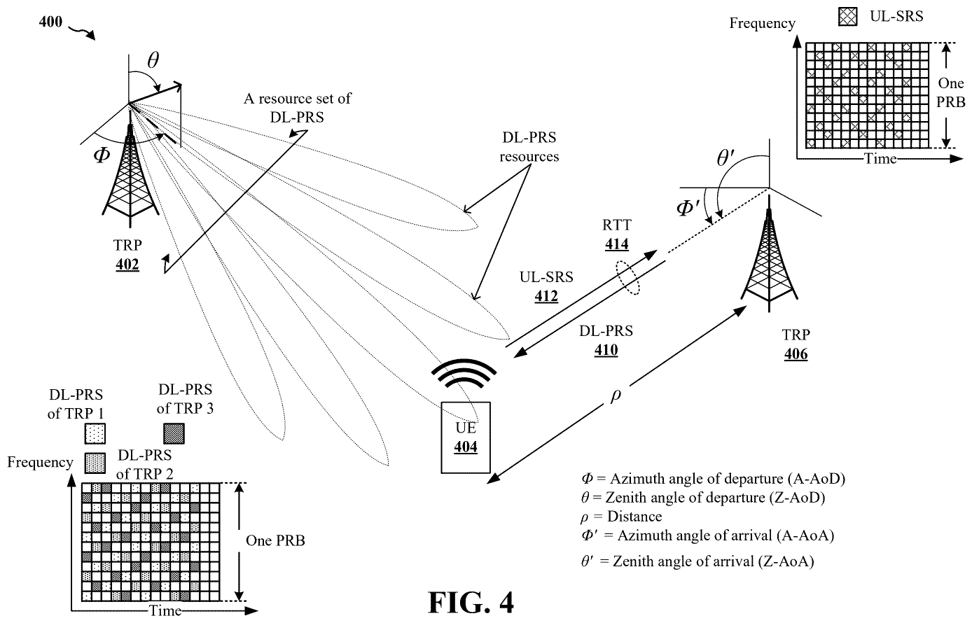

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle-of-arrival (A-AoA) and zenith angle-of-arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to the network-based positioning described in connection with FIG. 4, various positioning methods/mechanisms have also been developed for localizing or tracking the position of a target. These positioning methods/mechanisms may be classified into active positioning (which may also be referred to and used interchangeably with “active localization”) and passive positioning (which may also be referred to and used interchangeably with “passive localization”). For active positioning, a wireless device may locate a target based on signals transmitted from the target. For example, the target may be attached or configured with a radio frequency (RF)-capable device/component, such as a tag (e.g., an RF tag), a Global Positioning System (GPS)/wireless tracker, a device/component capable of transmitting/receiving positioning reference signals, a device/component capable of performing or responding to ranging/radar operations, etc. Then, based on signals transmitted from the target (or from the RF-capable device/component attached to the target), the wireless device may calculate or estimate the location of the target. On the other hand, for passive positioning, a target may be localized and tracked without attaching an RF-capable device/component to the target. For example, RF radars, light detection and ranging (Lidars), sonars, and/or cameras are example technologies/components that may be used by a wireless device for passive positioning, where the wireless device may locate a target based on images or based on reflection of signals, etc.

A wireless device may be able to locate and track another wireless device based on using one or more tracking/ranging technologies. For purposes of the present disclosure, tracking technologies may refer to methods and systems that are used for estimating, monitoring, and/or following the movements/locations of a target (e.g., an object, a person, an animal, a vehicle, etc.) over time. Tracking technologies may have different applications across various industries, and may use different principles and devices to achieve the tracking. Depending on implementations, some tracking technologies may be based on ranging operations, which may be referred to as ranging technologies. A ranging operation/technology may refer to a method/technique that is used to measure the distance between two points or objects. An example of ranging operation/technology may include a user locating a target device (e.g., a Bluetooth® device such as a pair of earbuds) using a mobile device (e.g., a smartphone), where the mobile device may continue to estimate the distance and/or location of the target device based on signals from the target device. Depending on the context, in some examples, the term “track/tracking” may be used interchangeably with the term “position/positioning” or “location/locationing.” For example, a wireless device may be configured to track a target based on estimating the position/location of the target using Wi-Fi technologies, which may be referred to as Wi-Fi tracking or Wi-Fi positioning/locationing. Similarly, depending on the context, in some examples, the term “tracking” may be used interchangeably with the term “ranging.” For example, a wireless device may be configured to track a target based on performing ranging against the target using UWB technologies, which may be referred to as UWB/UWB-based tracking or ranging.

The tracking technologies may be used in various fields such as surveying, navigation, robotics, telecommunications, etc. Examples of tracking technologies may include:
(1) global navigation satellite system (GNSS)/global positioning system (GPS) tracking-GNSS/GPS tracking relies on a network of satellites to provide real-time location information. GNSS/GPS receivers, often embedded in devices like smartphones, vehicles, or wearables, may determine their precise location and movement.
(2) radio-frequency identification (RFID) tracking—RFID technology uses radio waves to identify and track objects equipped with RFID tags, where these RFID tags may include electronic information that can be read by RFID readers, enabling the tracking of items in logistics, inventory management, and access control.
(3) Bluetooth® (BT) tracking—Bluetooth technology may be used for tracking by measuring the signal strength between devices. Bluetooth channel sounding (CS) (BTCS) is another technique that may also be used for tracking by measuring the round-trip-time (RTT)/the phase delay of RF signals between devices. Bluetooth beacons or tags may be attached to objects or carried by individuals, and their proximity to Bluetooth receivers may be used to estimate their location.
(4) Wi-Fi® tracking—Wi-Fi tracking may involve using signals from Wi-Fi access points (APs) to estimate the location of target devices. This tracking method is often suitable for indoor environments, such as malls and airports, for tracking people or assets.
(5) cellular tracking—mobile network infrastructure may be able to track devices through the triangulation of cell tower signals. The approximate location of a mobile device can be determined by analyzing the signals it receives from nearby cell towers.
(6) inertial navigation systems—these systems may use accelerometers and gyroscopes to track changes in velocity and orientation.
(7) computer vision tracking—advanced computer vision technologies, including object recognition and tracking algorithms, may enable cameras and sensors to track the movement of objects or people based on visual data.
(8) ultra-wideband (UWB) tracking—UWB tracking may utilize signals with very high frequency ranges or bandwidths. UWB technology transmits data using a broad spectrum of frequencies, enabling precise and accurate tracking of objects or individuals in both indoor and outdoor environments. UWB tracking systems typically operate in the frequency range of 3.1 to 10.6 gigahertz.

As discussed above, ranging operations/technologies may refer to methods/techniques that is used to measure the distance between two points or objects. Examples of ranging operations/technologies may include:
(1) triangulation—triangulation involves measuring the angles between an observer and two known points or landmarks. By using trigonometry, the distance to the object may be calculated or estimated.
(2) time of flight (ToF)—ToF technology measures the time taken for a signal (such as light or sound) to travel from a transmitter to a target and back to a receiver. By knowing the speed of the signal, usually the speed of light or sound, the distance may be calculated or estimated.
(3) GNSS—GNSS systems, such as GPS, global navigation satellite system (GLONASS), Galileo, and BeiDou, use signals from satellites to determine the position of a receiver on Earth. By analyzing the amount of time it takes for signals from multiple satellites to reach the receiver, its position (including distance) may be calculated or estimated.
(4) RFID—RFID technology uses electromagnetic fields to automatically identify and track tags attached to objects. The distance between the reader and the RFID tag may be estimated based on the strength of the received signal.
(5) ultrasonic ranging—ultrasonic ranging involves emitting ultrasonic pulses and measuring the time it takes for the pulses to bounce back from the object. The speed of sound in the medium determines the distance.
(6) laser ranging (e.g., light detection and ranging (Lidar))—laser ranging uses lasers to measure the distance to a target by calculating the time it takes for laser pulses to travel to the target and back.

Among the aforementioned tracking/ranging technologies, UWB, Bluetooth, and/or Wi-Fi based tracking/ranging have continued to be widely used and developed for most wireless devices (e.g., consumer devices such as mobile phones, smart watches, etc.) due to their accessibility and tracking/ranging precisions.

UWB tracking/ranging may refer to using a UWB device/technology to locate and track objects, people, or assets within a certain range. A UWB device (e.g., a device that is capable of performing UWB tracking/ranging) may use pulse-based radio signaling (e.g., Short-pulse-UWB) instead of orthogonal frequency division multiplexing (OFDM)-based signaling (e.g., Multi-Band (MB)-OFDM-UWB (MB-OFDM-UWB)). Short-pulse-UWB signaling may transmit with the energy for each bit spread over the entire UWB channel bandwidth (e.g., 1.37 GHz, 4 GHz, etc.) with varying pulse amplitude and/or pulse polarity without using a RF carrier while MB-OFDM-UWB may transmit each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g., Gaussian pulses, Monocycle pulses, Hermite pulses, etc.) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high-speed Analog-to-Digital converter (ADC) and a high-speed Digital-to-Analog Converter (DAC) to be able to handle the very wide frequency band used; however, there may be other ways to handle the need for ultra-fast sampling such as using Time Hopping techniques, Direct Sequence coding techniques, etc.

MB-OFDM-UWB may divide up spectrum into several frequency sub-bands and OFDM is applied within each band; whereas, other OFDM systems may typically operate within a fixed frequency band. The complex waveform created by combining the multiple-sub-bands results in a final waveform that used for transmission for MB-OFDM-UWB. MB-OFDM-UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

Bluetooth tracking/ranging may refer to using Bluetooth device/technology to locate and track objects, people, or assets within a certain range. This technology may rely on Bluetooth-enabled devices, such as smartphones, tablets, or specialized Bluetooth tags, to communicate with each other and determine their relative positions.

Bluetooth tracking may include beacon-based tracking and Bluetooth low energy (LE) tracking. Beacon-based tracking may involve deploying Bluetooth beacons that emit Bluetooth signals at regular intervals. These signals are picked up by Bluetooth-enabled devices in the vicinity, such as smartphones or tablets. By measuring the signal strength and timing of these beacon signals, the receiving devices can estimate their proximity to the beacon. This information may then be used to determine the location of the Bluetooth-enabled device within the range of the beacon. Bluetooth LE tracking may enable devices to communicate over short distances while consuming minimal power. Bluetooth LE tracking systems may include attaching tags to objects or carried by individuals, and Bluetooth LE receivers (such as smartphones or dedicated receivers) that scan for these tags. The receivers detect the signals transmitted by the tags and use signal strength and other parameters to estimate the distance between the tag and the receiver. By triangulating signals from multiple receivers, the system can determine the location of the tagged object or person. Bluetooth channel sounding (CS) is a technique used in Bluetooth communication to measure time/phase delay of BT signals, such that distance between wireless devices may be estimated/measured more accurately.

Wi-Fi tracking/ranging may refer to using a Wi-Fi capable device/technology for monitoring and tracking the movement of devices within a Wi-Fi network's coverage area. Wi-Fi tracking may rely on the unique media access control (MAC) addresses of Wi-Fi-enabled devices, such as smartphones, tablets, and laptops, to identify and track them as they move within the network's range. For example, Wi-Fi tracking utilizes Wi-Fi access points (APs), which are devices that provide wireless network connectivity to devices within their range. These access points continuously broadcast Wi-Fi signals, allowing Wi-Fi-enabled devices to connect to the network. When Wi-Fi-enabled devices come within range of Wi-Fi access points, they may be configured to automatically send out probe requests, seeking available networks to connect to. Wi-Fi access points receive these probe requests and respond with probe responses containing information about the network, such as the service set identifier (SSID) and signal strength. Each Wi-Fi-enabled device may have a unique MAC address associated with its network interface. Wi-Fi tracking systems capture these MAC addresses from the probe requests and responses exchanged between devices and access points. By monitoring the signal strength and timestamps of probe requests and responses from multiple access points, Wi-Fi tracking systems may triangulate the position of Wi-Fi-enabled devices within the network's coverage area.

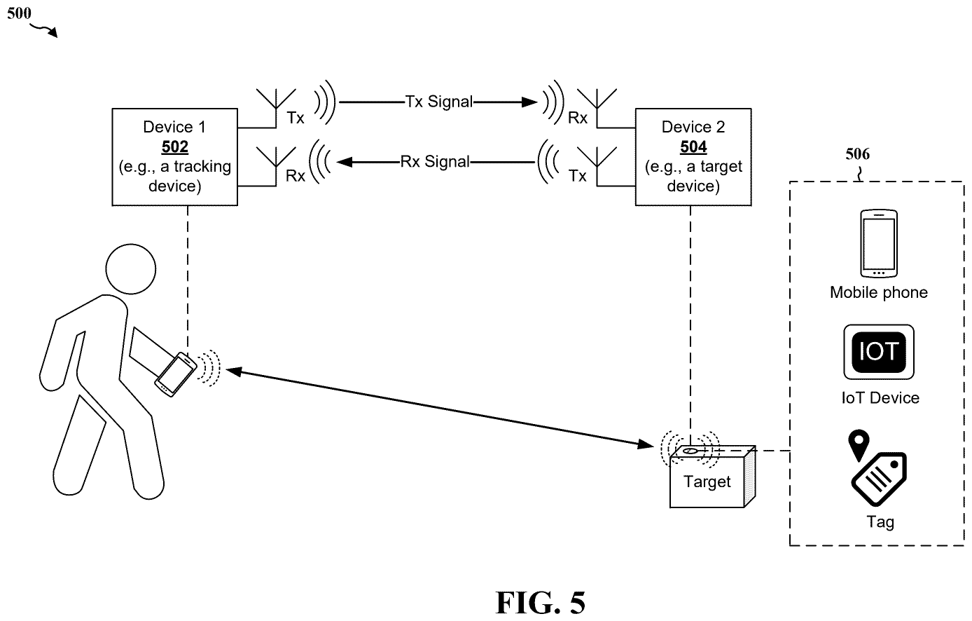

FIG. 5 is a diagram 500 illustrating an example of tracking/ranging (e.g., active positioning) in accordance with various aspects of the present disclosure. A first device 502 (which may also be referred to as a “tracking device,” a “ranging device,” or a “finder device” for purposes of the present disclosure) may be able to locate a second device 504 (which may also be referred to as a “target” or a “target device” for purposes of the present disclosure) based on transmitting signals (which may be referred to as “transmission (Tx) signals”) to the second device 504, and receive signals (which may be referred to as “reception (Rx) signals”) from the second device 504. Depending on implementations, the Rx signals may be signals reflected from the second device 504 (e.g., based on the Tx signals) or signals generated by the second device 504. Then, based on the time-of-flight (ToF) of the Tx signals and the Rx signals, the first device 502 may estimate the distance of the second device 504 from the first device 502. In some configurations, if the first device is also capable of measuring the angle-of-arrival (AoA) of the Rx signals, the first device 502 may also be able to estimate the direction of the second device 504 from the first device 502 (which may be referred to as the relative direction from the first device 502). As shown at 506, the second device 504 may be a mobile phone, an Internet of Things (IoT) device, or a tag (e.g., an RFID tag), and the localizing and/or tracking of the second device 504 may be based on using Bluetooth® tracking, Wi-Fi tracking, or UWB tracking, etc.

The tracking/ranging mechanisms discussed above may have a variety of applications in real life. For example, it may be common for users to lose small items (e.g., earbuds, keys, wallets, etc.) somewhere in their home, at work, or in school. If the lost items support some type of wireless tracking/ranging technology (e.g., UWB) as discussed in connection with FIG. 5, then the user may use a tracking device (e.g., the user's smart phone or similar device) to find the lost items near them. However, often either the lost items or the smartphone do not support any of the modern radios that enables wireless ranging (e.g., some devices do not have UWB/Wi-Fi/Bluetooth capabilities). As most electronic devices may have the capability to produce sound (either audible, or ultrasonic), aspects presented herein provide various mechanisms that enable sound produced by electronic devices to be used for locating the electronic devices, thereby extending the applicability of tracking/ranging to more electronic devices and fields. Aspects presented herein may also enable a wireless device (e.g., a smartphone with multiple microphones) to automatically locate the position of a lost device/item using the relative delay of the sound captured by the microphones, in combination with position/orientation information of the wireless device obtained from inertial measurement unit (IMU) sensors and camera.

There are various benefits and advantages of using the sound for locating a device/item (referring to as the “audio-based tracking/positioning” or “sound-based tracking/positioning” hereafter”). For example, while there may be mechanisms that enable a device to produce an audible sound in order for the device to be located by a person, there may be privacy and/or security issues. As such, in some scenarios, it may be more suitable to use ultrasounds for locating the device (e.g., using sound that is not audible to human). In other words, the user may want to use ultrasounds instead of audible sounds, for privacy, security, or convenience reasons. In addition, using ultrasounds may be easier, given the type of speaker available in the device, using ultrasounds may avoid alerting nearby users, waking up a sleeping person, etc., and using ultrasounds may allow/enable continuous tracking, without bothering nearby users. Another advantage of the audio-based tracking is it enables users with hearing disabilities to find a lost device. Also, sometimes the type of sound produced by a device may make it hard for a human to locate the device. For example, a smoke/CO2 alarm may be configured to beep intermittently when its batteries need to be replaced. However, it may be hard for a human to pinpoint which one is beeping if there are several of them near each other. In some examples, audio-based tracking may also enable a wireless device (e.g., a phone) to be aware of its physical environment. For example, information about relative position of a nearby device may be useful to enable other use cases, to trigger an action, or as an input for an on-device artificial intelligence (AI).

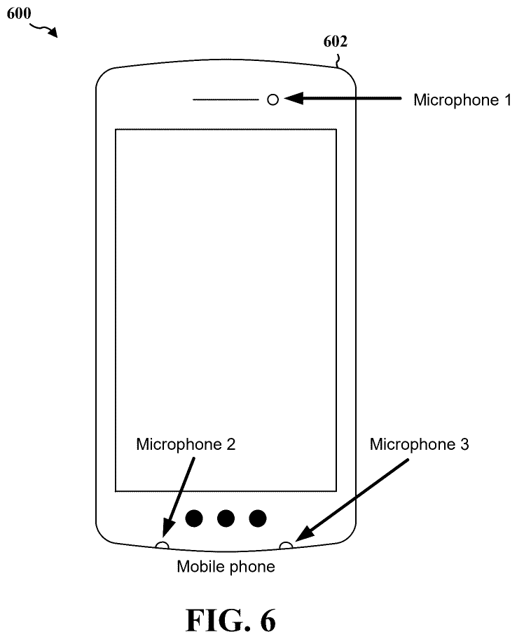

FIG. 6 is a diagram 600 illustrating an example of a mobile device with multiple microphones in accordance with various aspects of the present disclosure. Modern mobile phones typically have multiple microphones, designed to capture sound in different use cases. For example, as shown at 602, a mobile phone may have a first microphone (Microphone 1) at the top, a second microphone (Microphone 2) at the bottom left, and a third microphone (Microphone 3) at the bottom right. Because microphones are in different positions, any sound received by the microphones may be registered by the microphones at different times, depending on the extra time specified/needed for sound propagation. Thus, based on measuring this delay, the mobile phone may be able to estimate the direction of the incoming sound.

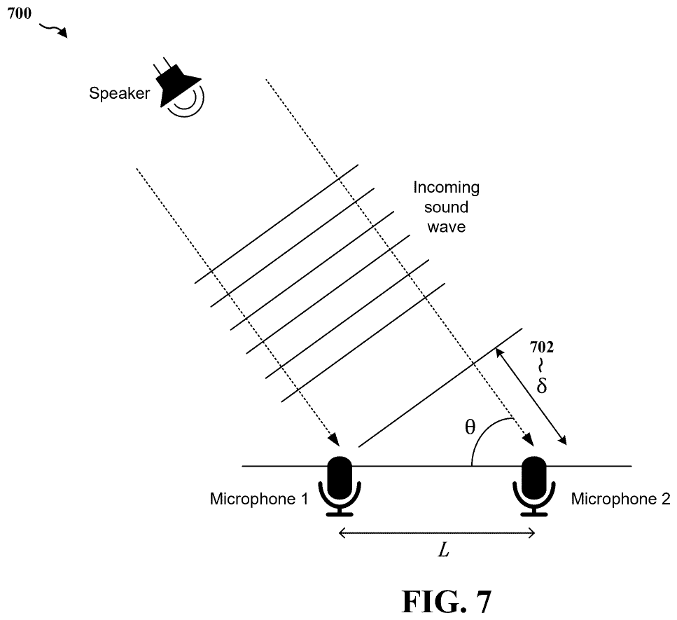

FIG. 7 is a diagram 700 illustrating an example angle of arrival (AoA) (in two-dimension (2D)) for sound in accordance with various aspects of the present disclosure. As shown at 702, due to the separation of the microphones in a device (e.g., as shown by FIG. 6), there may be a time delay (τ) for the sound wave to reach the second microphone after reaching the first microphone. This (distance) delay may be dependent on the microphone separation distance (L), the angle of arrival of the sound (θ), and the speed of sound (v, and may be calculate based on:

$$δ = L \cdot cos ( θ )$$

$$τ = \frac{δ}{v} = \frac{L \cdot cos ( θ )}{v}$$

$$θ = {cos}^{- 1} ( \frac{τ \cdot v}{L} )$$

There are various ways to measure the time delay (τ) for the sound received in each microphone. For example, if the sound is a pure tone, then it may be easier to measure the phase delay instead of measuring directly the time delay. However, there may be a limitation where a device may be able to just measure a phase between 0 and 2·π, which may create aliases (e.g., multiple time delays may map to the same phase as discussed below). For purposes of the present disclosure and in the context of sound, a pure tone may refer to a sound wave that consists of a single frequency. In other words, it is a sound wave that oscillates at one frequency without any harmonics or overtones mixed in. If the sound is not a pure tone (e.g., it has multiple components with different frequencies), then it may be possible to measure the time delay of the sound directly (e.g., based on performing an autocorrelation between two sound waveforms and finding the strongest peak).

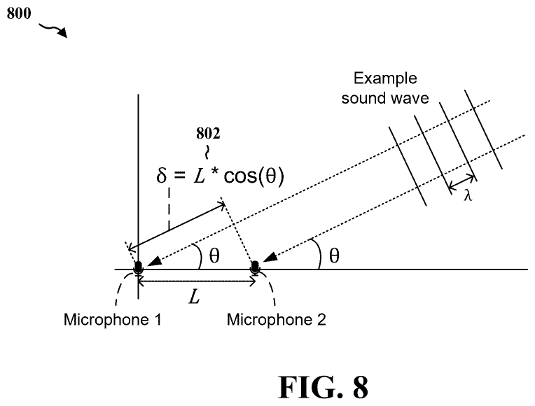

FIG. 8 is a diagram 800 illustrating an example phase difference of arrival (in 2D) for sound in accordance with various aspects of the present disclosure. As shown at 802, the extra/additional time (τ) it takes for sound wave to reach the left microphone (i.e., Microphone 1) may be calculated based on:

$$τ = \frac{δ}{v} = \frac{L \cdot cos ( θ )}{v}$$

If the sound is a pure tone, the soundwave registered by the left microphone may have a phase difference of arrival (PDoA) φ:

$$ϕ = \frac{2 π \cdot τ}{T} = \frac{2 π \cdot τ}{λ / v} = \frac{2 π \cdot τ \cdot v}{λ} = \frac{2 π \cdot L \cdot cos ( θ )}{λ}$$

However, as the phase delays may just be measured in the range of [−π, π] (e.g., to avoid AoA ambiguity discussed below), the following condition may be specified to be satisfied:

$$- π < \frac{2 π \cdot L \cdot cos ( θ )}{λ} < + π$$

$$\vert \frac{2 L \cdot cos ( θ )}{λ} \vert < 1$$

$$L < \frac{λ}{2}$$

Table 2 below shows an example of maximum microphone separation for pure tones to avoid AoA ambiguity.

TABLE 2
Example Maximum Microphone Separation

| Sound | Sound | Max microphone |
|---|---|---|
| Frequency | Wavelength λ | separation λ/2 |
| (Hz) | (cm) | (cm) |
| 20 | 1715.0 | 857.5 |
| 43 | 796.0 | 398.0 |
| 93 | 369.5 | 184.7 |
| 200 | 171.5 | 85.8 |
| 431 | 79.6 | 39.8 |
| 928 | 36.9 | 18.5 |
| 2000 | 17.2 | 8.6 |
| 4309 | 8.0 | 4.0 |
| 9283 | 3.7 | 1.8 |
| 20000 | 1.7 | 0.9 |

As shown by FIG. 6, a modern phone may have multiple microphones. If the two microphones at the top and bottom left (e.g., Microphone 1 and Microphone 2) are separated by approximately 14 cm, while the microphones at the bottom left and bottom right (e.g., Microphone 2 and Microphone 3) are separated by approximately 7.6 mm. A 14 cm separation may be considered optimal for a sound frequency a bit below 1.2 kHz, while a 7.6 mm separation is optimal for a bit below 21.7 kHz. Assuming this phone is configured to find the location of a beeping smoke detector, where the beeping smoke detector is configured to emit sounds with frequencies in the range from 3 kHz to 4 kHz. This may translate to wavelengths in the range 11 cm to 8.28 cm, which would specify microphone separations in the range from 5.5 cm to 4.14 cm.

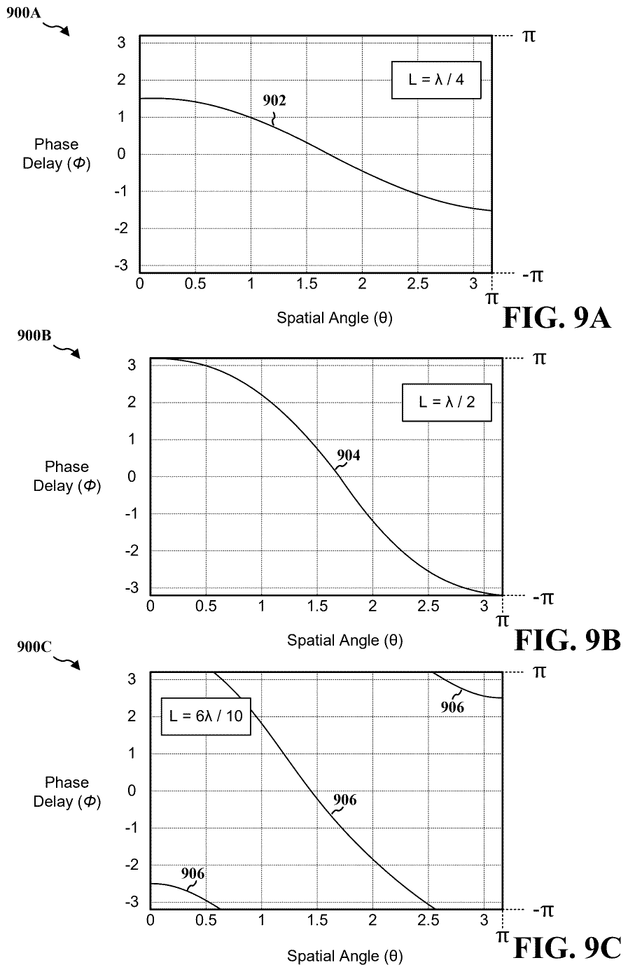

FIG. 9A is a diagram 900A illustrating an example relationship between sound wavelength (A) and microphone separation (L) in accordance with various aspects of the present disclosure. As shown at 902, if L<λ/2, then the phase delay (φ) does not exceed the range [0,2π]. So, there is no ambiguity when computing the spatial angle (θ). In other words, given a measured phase delay (φ), the spatial angle (θ) may be determine based on

$$θ = {cos}^{- 1} ( \frac{ϕ λ}{2 π L} )$$

without ambiguity.

FIG. 9B is a diagram 900B illustrating an example relationship between sound wavelength (A) and microphone separation (L) in accordance with various aspects of the present disclosure. As shown at 904, if L=λ/2, then for any spatial angle θ≠{0, π}, there is no ambiguity. However, if the phase delay (φ) is exactly equal to w (which is the same as −π), there may be an ambiguity (e.g., it may not be certain whether θ=0 or θ=π).

FIG. 9C is a diagram 900C illustrating an example relationship between sound wavelength (λ) and microphone separation (L) in accordance with various aspects of the present disclosure. As shown at 906, if L>λ/2, then there may be several values of spatial angles θ (e.g., near 0 and π). In other words, there may be aliasing (e.g., more than one angle θ is mapped to the same phase delay φ).

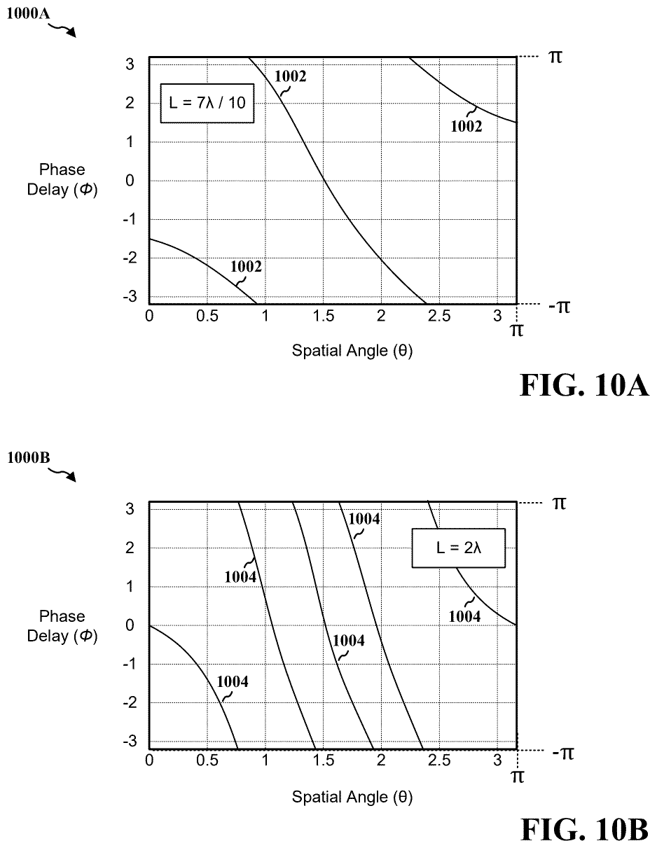

FIG. 10A is a diagram 1000A illustrating an example relationship between sound wavelength (λ) and microphone separation (L) in accordance with various aspects of the present disclosure. As shown at 1002, as microphone separation (L) keeps increasing, the range of values of spatial angles (θ) where there is aliasing keeps getting larger.

FIG. 10B is a diagram 1000B illustrating an example relationship between sound wavelength (λ) and microphone separation (L) in accordance with various aspects of the present disclosure. As shown at 1004, if L>>λ/2, then all spatial angles (θ) may have aliasing. For this extreme case, it may be impossible to recover the true spatial angle (θ) from a phase delay (φ) measurement because of aliasing. As such, the location algorithm may be demanded to take this into account.

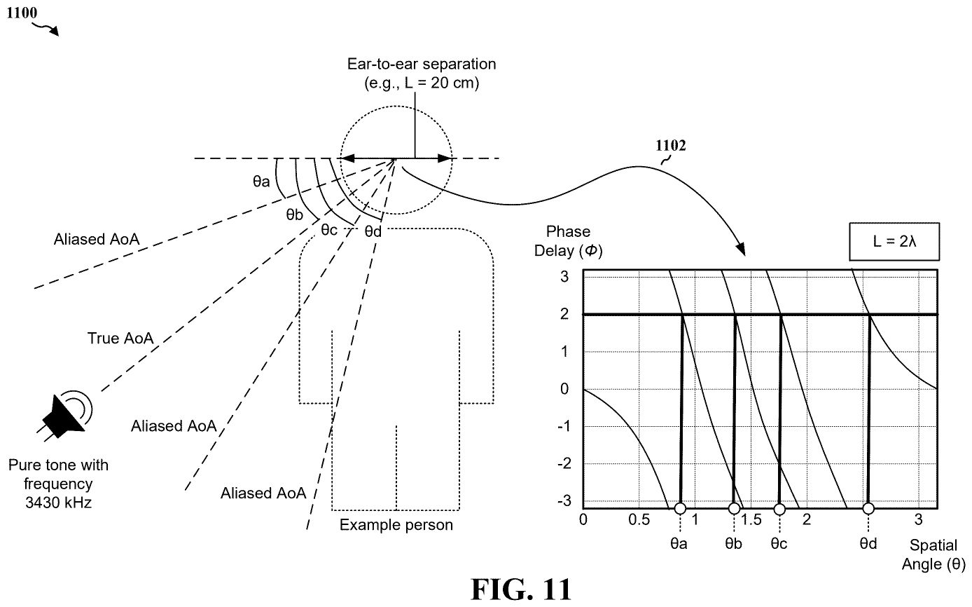

FIG. 11 is a diagram 1100 illustrating an example of why some pure tones may be hard to pinpoint in accordance with various aspects of the present disclosure. As shown at 1102, if a pure tone has a wavelength (λ) half of the ear-to-ear separation (L)

$$( e . g . , L = 20 cm , λ = \frac{L}{2} = 10 cm , f = \frac{v}{λ} = 3430 Hz ) ,$$

then the sound may appear to come from at least four different directions (e.g., from the perception of the example person). Thus, the person may need to rotate the head left/right to figure out the true AoA.

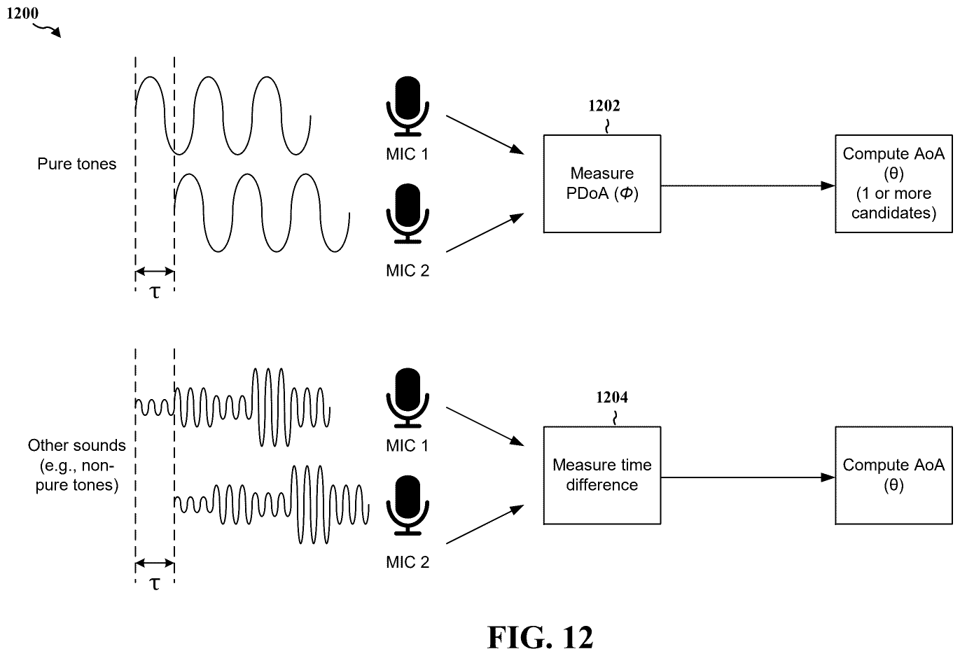

FIG. 12 is a diagram 1200 illustrating an example of estimating angle of arrival using PDoA (for pure tones) or time delay (for other soundwaves such as non-pure tones) in accordance with various aspects of the present disclosure. As shown at 1202, when measuring the time delay (τ) for the sound received in each microphone, if the sound is a pure tone, then it may be easier to measure the phase delay (φ) instead of measuring directly the time delay. On the other hand, as shown at 1204, if the sound is not a pure tone (e.g., it has multiple components with different frequencies, which may collectively be referred to as “non-pure tone(s)” hereafter), then it may be possible to just measure the time delay of the sound directly. However, as discussed above, when using pure tones, if microphone separation

$$L > \frac{λ}{2}$$

(where λ is the sound wavelength), there might be multiple values of θ that are consistent with the same PDoA (φ).

In one aspect of the present disclosure, depending on whether a finder device (e.g., the first device 502 as discussed in connection with FIG. 5) is capable of requesting a target device (e.g., the second device 504), such as via wireless communications, to choose the sound waveform (to produce), there may be two difference cases: a non-collaborative case and a collaborative case. For the non-collaborative case, the “target device” may produce some default sound which cannot be optimized for the microphones of the finder device. For example, a CO2/smoke detector may be designed to produce a beep sound at the same frequency. In this case, it is possible that the frequency of the sound is such that the microphone separation does not meet the L<λ/2 condition. Two possible scenarios: (1) L<λ/2: a single AoA (θ) may be computed given a phase delay, such as described in connection with FIG. 9A, and (2) L>λ/2: there are multiple angles {θ_{A}, θ_{B}, . . . } which are possible, such as described in connection with FIGS. 9C, 10A, 10B, and 11. However, if the target device is capable of producing a multi-frequency sound, then it is possible that the AoA can be estimated accurately via time delay. For the collaborative use case, the finder device may have the capability to request the target device (e.g., via wireless messaging) to produce a sound that is optimized to produce a single AoA, given or based on the microphone separation L of the finder device, ensuring L<λ/2. Alternatively or additionally, the finder device may ask the target device to produce a sound with multiple frequencies, to make it easier to measure the time delay between microphones.

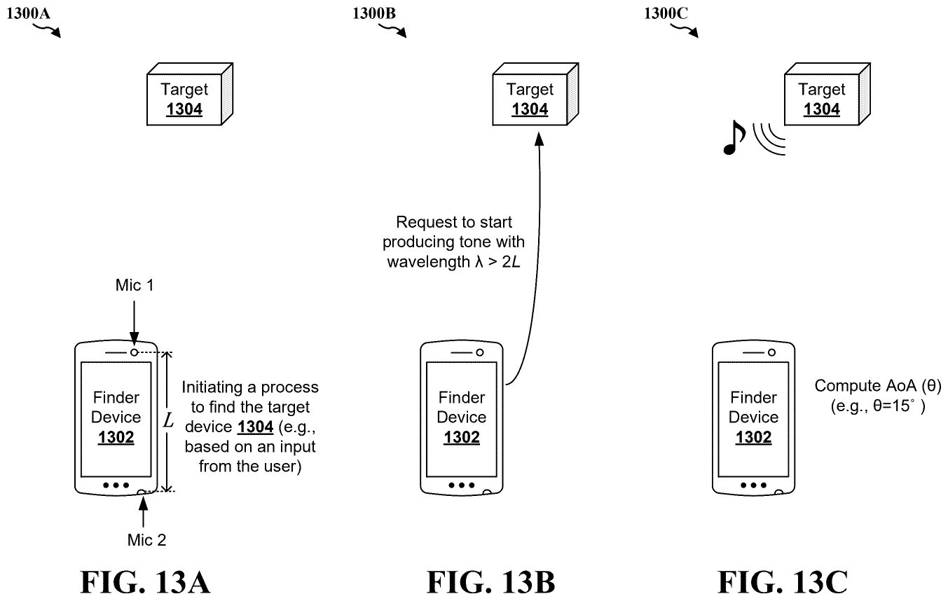

FIGS. 13A, 13B, and 13C are diagrams 1300A, 1300B, and 1300C, respectively, illustrating an example of a collaborative case where a target device may be configured/requested to produce the sound using a sound frequency that is selected based on the microphone separation of the finder device in accordance with various aspects of the present disclosure. As shown by the diagram 1300A, a finder device 1302 (e.g., a UE, a mobile phone, the first device 502, etc.) may include at least a first microphone (Mic 1) and a second microphone (Mic 2) with the separation distance (L). The finder device 1302 may be requested by a user to location a target device 1304 (e.g., a pair of ear buds, another UE, the second device 504, etc.), such as based on receiving an input from the user.

As shown by the diagram 1300B, after the process to locate the target device 1304 is initiated, the finder device 1302 may be configured to transmit (e.g., wirelessly) a message to the target device 1304 to start producing sound. Based on the microphone separation (L) of the finder device 1302, the finder device 1302 may request (e.g., using the message) the target device 1304 to choose and produce a sound frequency that meets L<λ/2. For example, the finder device 1302 may indicate the microphone separation (L) to the target device 1304 for the target device 1304 to derive, select, and produce the sound frequency (i.e., the target device 1304 is configured to calculate the sound frequency that meets L<λ/2 based on the given L). In another example, the finder device 1302 may provide a range of frequencies that meets L<λ/2 to the target device 1304, and the target device 1304 may choose and produce a sound frequency from the range of frequencies. In another example, the finder device 1302 may request the target device 1304 to produce a specific frequency that meets L<λ/2, and the target device 1304 may produce a sound using the specific frequency based on the request.

As shown by the diagram 1300C, after the target device 1304 starts to produce the sound based on the request (e.g., using a sound frequency that meets L<λ/2), the finder device 1302 may measure the phase delay (φ) on both microphones (e.g., Mic 1 and Mic 2), and the finder device 1302 may compute the AoA (θ) of the sound with no ambiguity, such as described in connection with FIGS. 7, 8, and 9A.

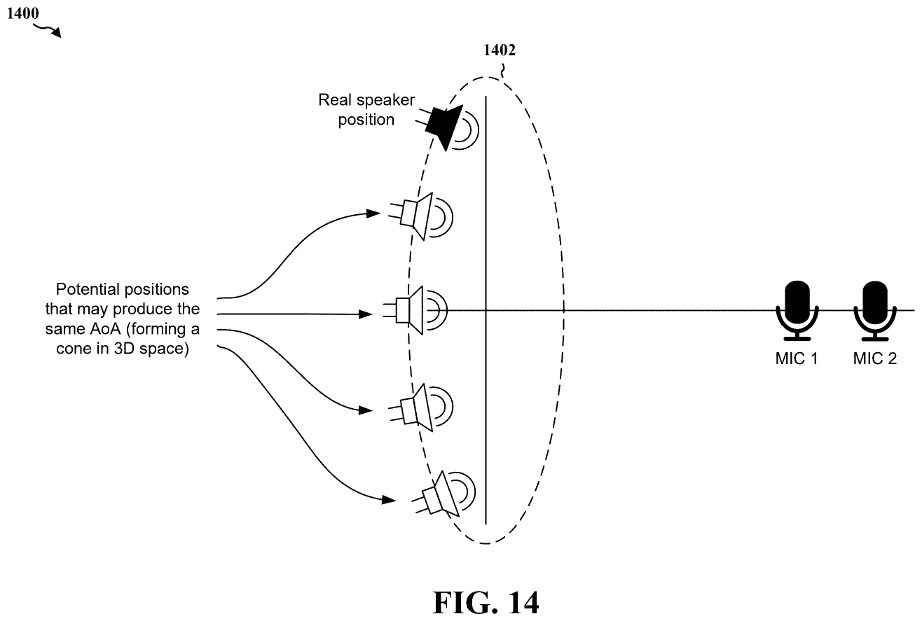

FIG. 14 is a diagram 1400 illustrating an example of estimating angle of arrival in a three-dimensional (3D) space in accordance with various aspects of the present disclosure. In real applications, when the finder device 1302 is measuring an AoA (θ) of the sound produced by the target device 1304, there may still be an ambiguity about the position of the target device 1304 in a 3D space. For example, as shown at 1402, there may be a 3D “cone” of positions that may produce the same AoA (θ). Thus, in the 3D space, there may be an ambiguity about where the target device 1304 is really located. As such, in another aspect of the present disclosure, the finder device 1302 may be configured to measure the AoA (θ) of the sound produced by the target device 1304 from multiple positions and/or orientations to resolve the ambiguity.

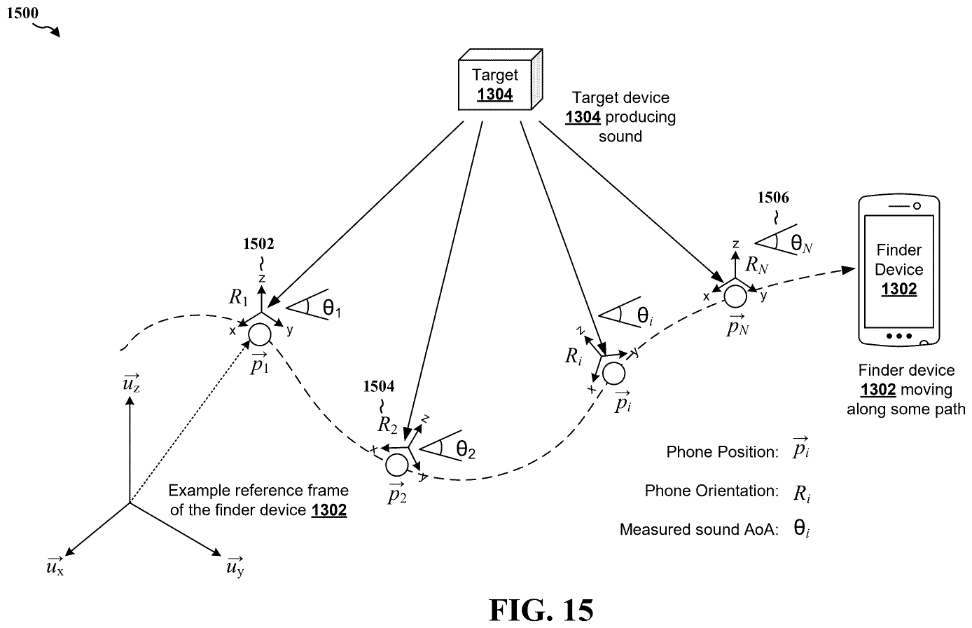

FIG. 15 is a diagram 1500 illustrating an example of a finder device tracking the AoA of sound and also its position/orientation simultaneously in accordance with various aspects of the present disclosure. In another aspect of the present disclosure, the finder device 1302 may be configured to measure the AoA (θ) of the sound produced by the target device 1304 from multiple positions and/or orientations. For example, the finder device 1302 may measure sound AoA from multiple positions/orientations, while recording those positions and orientations (e.g., using information obtained from camera and/or IMU sensors, etc.). As an illustration, when the finder device 1302 is at a first position (\vec{p₁}) and/or a first orientation (R₁) as shown at 1502, the finder device 1302 may measure a first AoA (θ₁) of the sound produced by the target device 1304. At 1504, when the finder device 1302 is at a second position (\vec{p₂}) and/or a second orientation (R₂) as shown at 1504, the finder device 1302 may measure a second AoA (θ₂) of the sound produced by the target device 1304. As shown at 1506, the finder device 1302 may repeat this process to collect multiple (N) AoAs from multiple positions and orientations. For purposes of the present disclosure, the position of the finder device 1302 and the orientation of the finder device 1302 may collectively be referred to as a “pose” of the finder device. For example, pose(s) of the finder device 1302 may include a set of locations (e.g., a set of coordinates) and/or a set of orientations.

In some implementations, if the finder device 1302 is static (e.g., not moving), the finder device 1302 (or the tracking application running on the finder device 1302) may be configured to display an indication that requests the user of the finder device 1302 to move and/or rotate the finder device 1302.

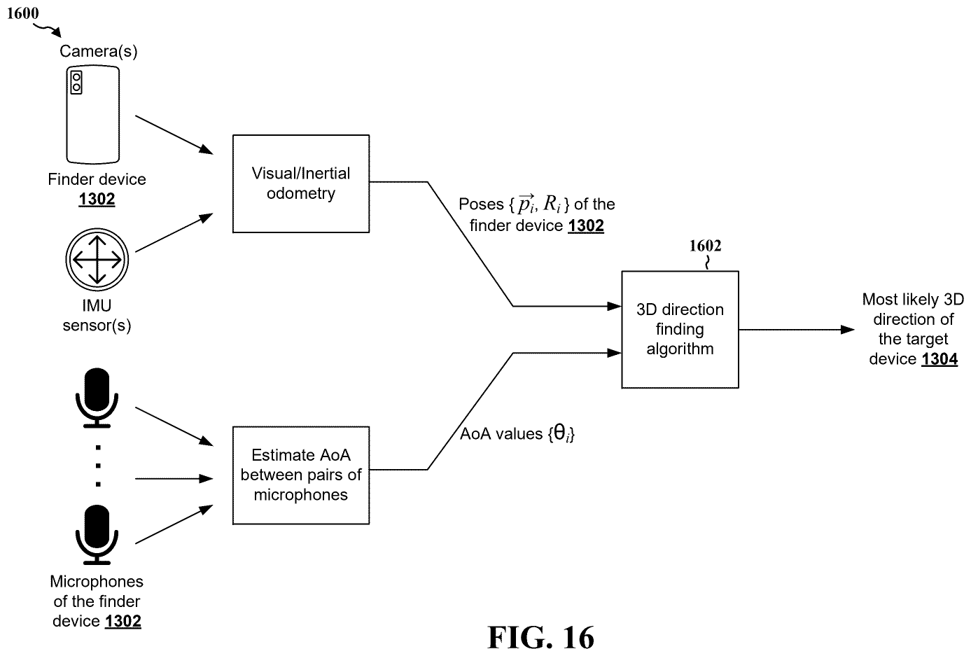

FIG. 16 is a diagram 1600 illustrating an example of a finder device estimating the position of a target device based on the poses of the finder device and the estimation of AoA between pairs of microphones in accordance with various aspects of the present disclosure. After the finder device 1302 has collected multiple AoA measurements {θᵢ} of the sound generated from the target device 1304 and also tracking/recording its positions {\vec{pᵢ}} and orientations {Rᵢ} (i.e., its poses) as described in connection with FIG. 15, the finder device 1302 may then compute/calculate what is the most likely position of (or the direction towards) the target device 1304 that is consistent with those measurements. In one example, as shown at 1602, the poses {\vec{pᵢ}, Rᵢ} of the finder device 1302 and the estimated AoA between (multiple/different) pairs of microphones may be inputted into a 3D direction finding algorithm, and the 3D direction finding algorithm may output the most likely 3D direction of the target device 1304 (with respect to the finder device 1302). For example, algorithms that are used for calculating the direction of a target device based on AoA of the RF signals transmitted from the target device may be used to compute the 3D direction to target device, e.g., using 2D AoA information plus displacement/rotation of the finder device, e.g., replacing the RF frequency/wavelength with the sound frequency/wavelength and the speed of light (c=3·10⁸ m/s) with the speed of sound (v=340 m/s), etc.

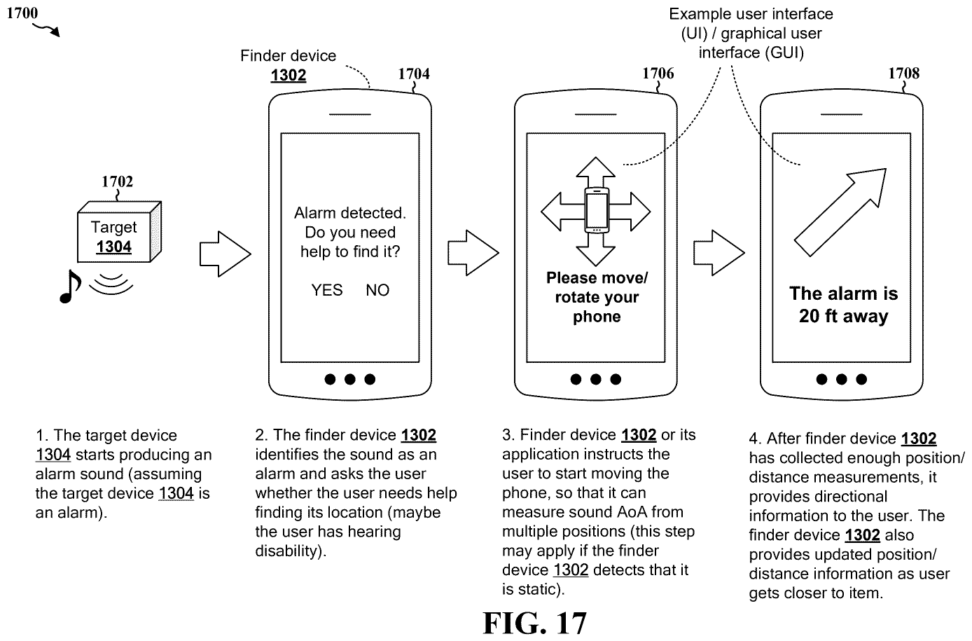

FIG. 17 is a diagram 1700 illustrating an example user experience of a finder device locating a target device based on sound in accordance with various aspects of the present disclosure. In one example scenario, the finder device 1302 may be used for assisting a user with hearing disability to locate the target device 1304 (assuming the target device 1304 is an alarm for purposes of demonstration). As shown at 1702, the target device 1304 may start producing an alarm sound. As shown at 1704, after the finder device 1302 detects the sound from the target device 1304, the finder device 1302 may identify the sound as an alarm and asks the user whether the user wants to locate the alarm (e.g., the user may have hearing disability). As shown at 1706, in some scenarios, the finder device 1302 or its application may instruct the user to start moving the finder device 1302, so that the finder device 1302 may measure the AoA of the alarm sound from multiple positions. This step may apply if the finder device 1302 detects that the finder device 1302 is static (e.g., it is unable to collect AoA measurements from different poses), and the step may not apply if the finder device 1302 is in mobility (e.g., is moving). As shown at 1708, after the finder device 1302 has collected enough position/distance measurements, the finder device 1302 may start providing directional information to the user (e.g., via user interface (UI) and/or graphical user interface (GUI), etc.). The finder device 1302 may continue to provide updated position/distance information of the target device 1304 as the user gets closer to the target device 1304.

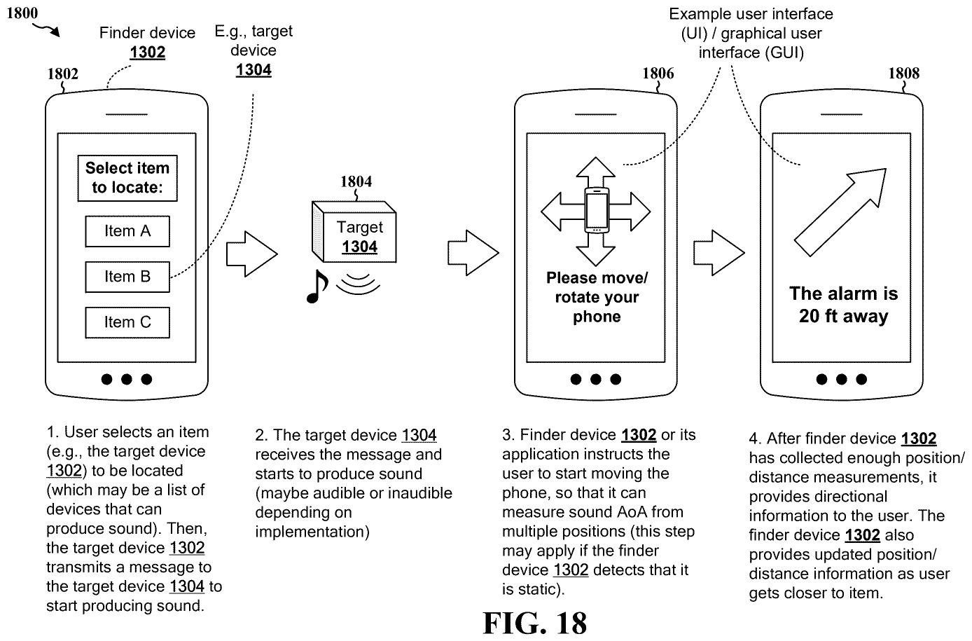

FIG. 18 is a diagram 1800 illustrating an example user experience of a finder device locating a target device based on sound in accordance with various aspects of the present disclosure. In another example scenario, the finder device 1302 may be used for locating the target device 1304 (e.g., the target device 1304 is a pair of earbuds, a tracking device attached to a wallet/key, etc.). As shown at 1802, the finder device 1302 (e.g., a first UE, a wireless device, or a mobile phone, etc.) or an application running on the finder device 1302 may instruct the user to select an item (e.g., from a list of detected items) for tracking. After the user selects the target device 1304 (e.g., assuming it is “Item B”) to be located, the finder device 1302 may transmit a message (e.g., a request) to the target device 1304 to start producing sound (e.g., using a sound wavelength λ2L), such as described in connection with FIGS. 13A, 13B, and 13C. As shown at 1804, after the target device 1304 receives the message/request from the finder device 1302, the target device 1304 may start producing the sound (e.g., using a sound wavelength λ2L). As shown at 1806, in some scenarios, the finder device 1302 or its application may instruct the user to start moving the finder device 1302, so that the finder device 1302 may measure the AoA of the sound from multiple positions. This step may apply if the finder device 1302 detects that the finder device 1302 is static (e.g., it is unable to collect AoA measurements from different poses), and the step may not apply if the finder device 1302 is in mobility (e.g., is moving). As shown at 1808, after the finder device 1302 has collected enough position/distance measurements, the finder device 1302 may start providing directional information to the user (e.g., via UI and/or GUI, etc.). The finder device 1302 may continue to provide updated position/distance information of the target device 1304 as the user gets closer to the target device 1304.

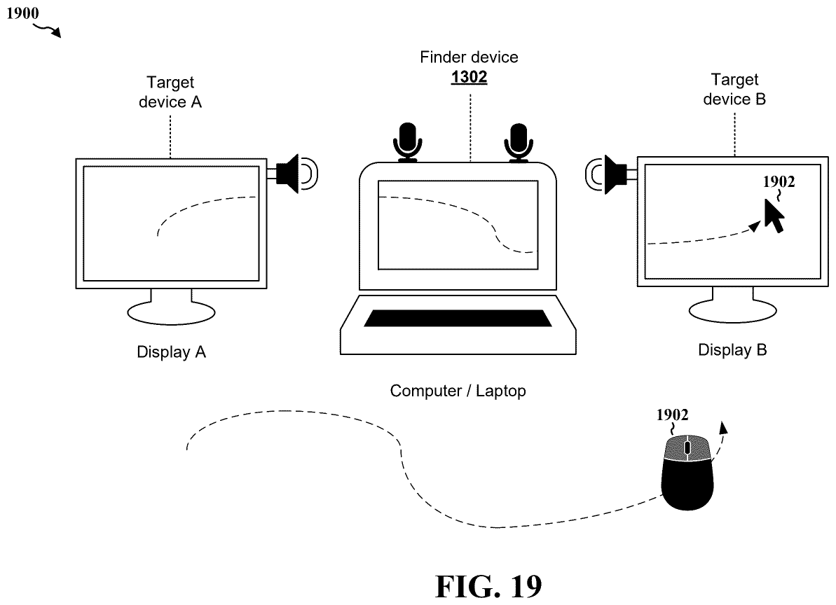

FIG. 19 is a diagram 1900 illustrating an example of multiple devices continuously tracking their positions based on sound (e.g., ultrasound) in accordance with various aspects of the present disclosure. In another example scenario, the finder device 1302 (assuming it is a laptop that is configured to detect the relative position of one or more externals displays (e.g., one or more target devices), using ultrasounds produced by/from the displays periodically, and using the microphones of the finder device 1302 to detect the phase difference of the sounds coming from each display. As shown at 1902, this way, the Operating System (OS) of the laptop may extend the desktop correctly to the corresponding display as the user moves the cursor across multiple screens.

Aspects presented herein may enable a wireless device with multiple microphones to rely on measuring the time or phase difference between the sound captured by each microphone of the wireless device, and then using that information (in conjunction with the position/orientation of the wireless device relative to a reference frame) to determine the direction in 3D space from which the sound is coming. Then, the information is conveyed to the user with an appropriate graphical UI that shows the direction where the sound is coming from. Aspects presented herein may also support using ultrasounds (sound waves of higher frequency, which cannot be heard by humans) to enable uses cases in which audible sounds may not be appropriate (e.g., not to bother people with continuous beeping or for privacy concerns).

In one aspect, a target device may be configured to produce sound (either audible or ultrasound). A finder device with two or more microphones at known locations may measure the AoA of the incoming sound. The finder device has the capability to track its own pose (e.g., position+orientation) using camera and/or IMU sensors, etc. The finder device captures multiple AoA and pose samples (synchronized with each other). The finder device then determines the most likely relative position of the target device (the one most likely to have produced the AoA samples given finder device pose samples). The finder device displays the relative position of the target device to the user (or provides input to some other device or software).

In another aspect of the present disclosure, if the finder device is able to communicate with the target device wirelessly, the finder device may request/ask the target device to produce a sound that is optimized for the microphones of the finder device (for the specific separation and bandwidth). The finder device and the target device may also negotiate the specific sound waveform based on capabilities of the finder device and the target device. In some implementations, the finder device may request/ask the user to move/rotate the finder device to better locate the target device. The finder device may detect an incoming sound as an alarm and ask the user if the user needs help locating it.

Today there are no solutions in the market that use sound AoA to find target position using a smartphone. Existing solutions may rely on the user following the sound to find the lost device. Those existing solutions may not support ultrasound and may not be used by people with hearing disabilities. Aspects presented herein rely on phase/time difference of arrival of sound (captured with 2 or more microphones), in combination with phone position/orientation (computed from phone IMU sensors and cameras) to estimate the most likely position of the target device that is producing the sound. Thus, aspects presented herein enable the location of old devices that do not support wireless ranging technologies, and which could not be automatically located by a smartphone otherwise.

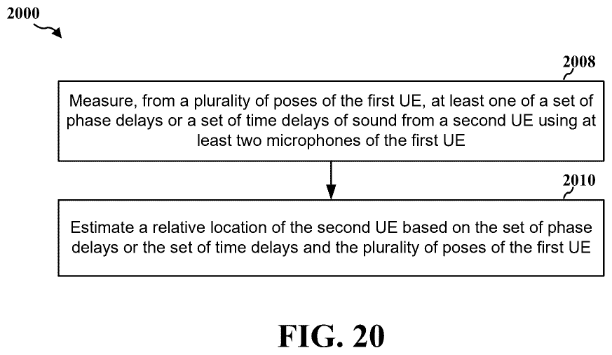

FIG. 20 is a flowchart 2000 of wireless communication at a user equipment (UE). The method may be performed by a UE (e.g., the UE 104, 404; the first device 502; the finder device 1302; the apparatus 2204). The method may enable a first UE with multiple microphones to rely on measuring the time or phase difference between the sound captured by each microphone of the first UE, and then using that information (in conjunction with the position/orientation of the first UE relative to a reference frame) to determine the direction in 3D space from which the sound is coming.

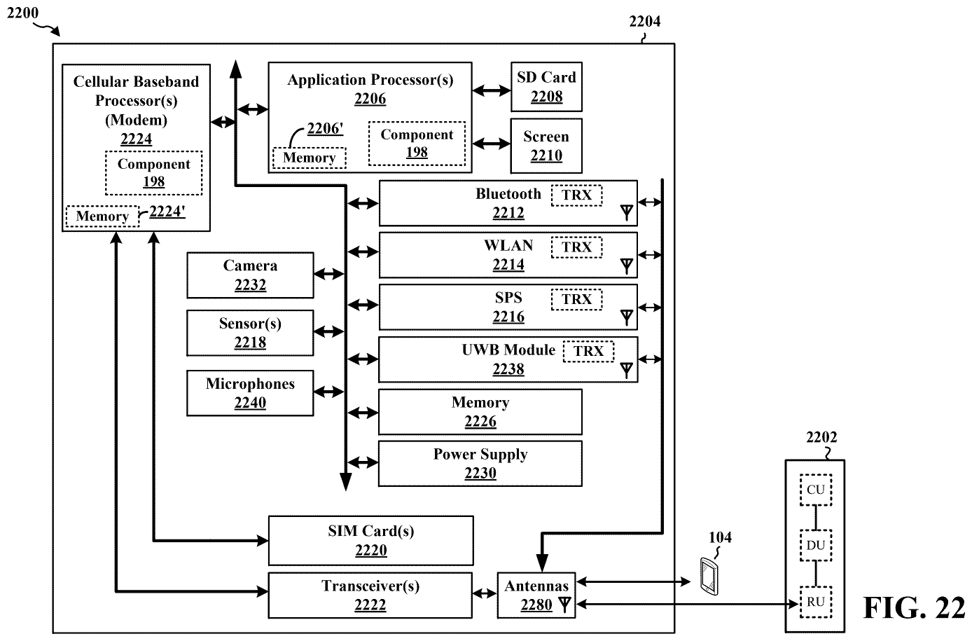

At 2008, the first UE may measure, from a plurality of poses of the first UE, at least one of a set of phase delays or a set of time delays of sound from a second UE using at least two microphones of the first UE, such as described in connection with FIGS. 13A, 13B, 13C, 14, 15 and 16. For example, as discussed in connection with FIG. 15, the finder device 1302 may be configured to measure the AoA (θ) of the sound produced by the target device 1304 from multiple positions and/or orientations. The measurement of the set of phase delays or the set of time delays of sound may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In one example, to measure at least one of the set of phase delays or the set of time delays of the sound from the second UE, the first UE may be configured to measure the set of time delays of the sound from the second UE if the sound is a multi-frequency sound.

At 2010, the first UE may estimate a relative location of the second UE based on the set of phase delays or the set of time delays and the plurality of poses of the first UE, such as described in connection with FIGS. 13A, 13B, 13C, 14, 15 and 16. For example, as discussed in connection with FIG. 16, after the finder device 1302 has collected multiple AoA measurements {θᵢ} of the sound generated from the target device 1304 and also tracking/recording its positions {\vec{pᵢ}} and orientations {Rᵢ} (i.e., its poses) as described in connection with FIG. 15, the finder device 1302 may then compute/calculate what is the most likely position of (or the direction towards) the target device 1304 that is consistent with those measurements. The estimation of the relative location of the second UE may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In one example, the first UE may transmit, to the second UE, a request to produce the sound, where measurement of at least one of the set of phase delays or the set of time delays of the sound from the second UE is based on transmission of the request, such as described in connection with FIGS. 13A, 13B, 13C, 14, 15 and 16. For example, as discussed in connection with FIG. 13B, after the process to locate the target device 1304 is initiated, the finder device 1302 may be configured to transmit (e.g., wirelessly) a message to the target device 1304 to start producing sound. Based on the microphone separation (L) of the finder device 1302, the finder device 1302 may request (e.g., using the message) the target device 1304 to choose and produce a sound frequency that meets L<λ/2. For example, the finder device 1302 may indicate the microphone separation (L) to the target device 1304 for the target device 1304 to derive, select, and produce the sound frequency (i.e., the target device 1304 is configured to calculate the sound frequency that meets L<λ/2 based on the given L). In another example, the finder device 1302 may provide a range of frequencies that meets L<λ/2 to the target device 1304, and the target device 1304 may choose and produce a sound frequency from the range of frequencies. In another example, the finder device 1302 may request the target device 1304 to produce a specific frequency that meets L<λ/2, and the target device 1304 may produce a sound using the specific frequency based on the request. The transmission of the request may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In some implementations, the first UE may further select a wavelength (λ) to be used for the sound based on a distance (L) between the at least two microphones of the first UE, where the distance (L) is less than half of the wavelength (λ) (L<λ/2) and the sound is a pure tone, where the request includes an indication of the wavelength (λ). In some implementations, to measure at least one of the set of phase delays or the set of time delays of the sound from the second UE, the first UE may be configured to measure the set of phase delays of the sound from the second UE.

In some implementations, the request indicates at least one of a range of wavelengths that can be used for the sound or a distance between the at least two microphones of the first UE.

In another example, the first UE may detect the second UE is emitting the sound, display an indication of whether to locate the second UE or the sound, and receive, based on the indication, a request to locate the second UE or the sound, where measurement of at least one of the set of phase delays or the set of time delays of the sound from the second UE is based on the request, such as described in connection with FIG. 17. For example, at 1702, the target device 1304 may start producing an alarm sound. At 1704, after the finder device 1302 detects the sound from the target device 1304, the finder device 1302 may identify the sound as an alarm and asks the user whether the user wants to locate the alarm. At 1708, after the finder device 1302 has collected enough position/distance measurements, the finder device 1302 may start providing directional information to the user. The detection of the second UE emitting the sound may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In some implementations, to measure at least one of the set of phase delays or the set of time delays of the sound from the second UE, the first UE may be configured to measure the set of phase delays of the sound from the second UE.

In another example, the first UE may track, while the first UE is moving, at least one of a set of orientations of the first UE or a set of locations of the first UE to obtain the plurality of poses of the first UE, such as described in connection with FIGS. 13A, 13B, 13C, 14, 15 and 16. For example, as discussed in connection with FIG. 15, the finder device 1302 may measure sound AoA from multiple positions/orientations, while recording those positions and orientations (e.g., using information obtained from camera and/or IMU sensors, etc.). The tracking of the set of orientations of the first UE or a set of locations of the first UE may be performed by, e.g., the tracking component 198, the plurality of microphones 2240, the camera 2232, the transceiver(s) 2222, the one or more sensors 2218, the cellular baseband processor(s) 2224, and/or the application processor(s) 2206 of the apparatus 2204 in FIG. 22.

In some implementations, the first UE may further display a request to move the first UE if the first UE is immobile.

In another example, the first UE may output an indication of an estimated relative position of the second UE, such as described in connection with FIGS. 17 and 18. For example, as discussed in connection with FIG. 17, at 1708, after the finder device 1302 has collected enough position/distance measurements, the finder device 1302 may start providing directional information to the user (e.g., via UI and/or GUI, etc.). The output of the indication may be performed by, e.g., the tracking component 198, the plurality of microphones 2240, the screen 2210, the transceiver(s) 2222, the one or more sensors 2218, the cellular baseband processor(s) 2224, and/or the application processor(s) 2206 of the apparatus 2204 in FIG. 22.

In some implementations, to output the indication of the estimated relative position of the second UE, the first UE may be configured to transmit the indication of the estimated relative position of the second UE, display the indication of the estimated relative position of the second UE via a screen, or store the indication of the estimated relative position of the second UE.

In another example, the first UE may display, via a UI, an estimated relative position of the second UE that includes at least one of: a direction of the second UE from the first UE, a distance of the second UE from the first UE, or an image or a description of the second UE, such as described in connection with FIGS. 17 and 18. For example, as discussed in connection with FIG. 17, at 1708, after the finder device 1302 has collected enough position/distance measurements, the finder device 1302 may start providing directional information to the user (e.g., via UI and/or GUI, etc.). The finder device 1302 may continue to provide updated position/distance information of the target device 1304 as the user gets closer to the target device 1304. The display of the estimated relative position of the second UE may be performed by, e.g., the tracking component 198, the plurality of microphones 2240, the screen 2210, the transceiver(s) 2222, the one or more sensors 2218, the cellular baseband processor(s) 2224, and/or the application processor(s) 2206 of the apparatus 2204 in FIG. 22.

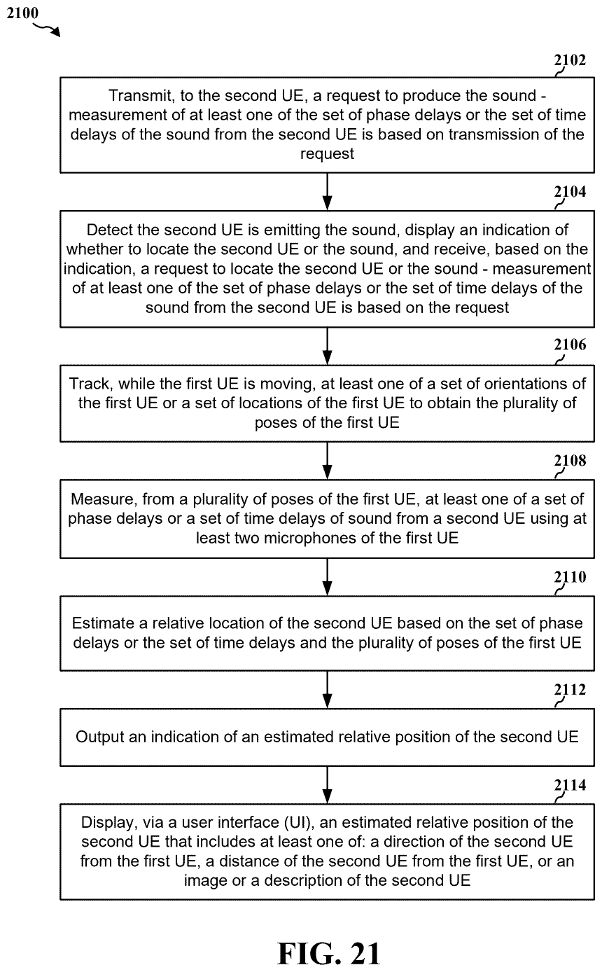

FIG. 21 is a flowchart 2100 of wireless communication at a user equipment (UE). The method may be performed by a UE (e.g., the UE 104, 404; the first device 502; the finder device 1302; the apparatus 2204). The method may enable a first UE with multiple microphones to rely on measuring the time or phase difference between the sound captured by each microphone of the first UE, and then using that information (in conjunction with the position/orientation of the first UE relative to a reference frame) to determine the direction in 3D space from which the sound is coming.

At 2108, the first UE may measure, from a plurality of poses of the first UE, at least one of a set of phase delays or a set of time delays of sound from a second UE using at least two microphones of the first UE, such as described in connection with FIGS. 13A, 13B, 13C, 14, 15 and 16. For example, as discussed in connection with FIG. 15, the finder device 1302 may be configured to measure the AoA (θ) of the sound produced by the target device 1304 from multiple positions and/or orientations. The measurement of the set of phase delays or the set of time delays of sound may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In one example, to measure at least one of the set of phase delays or the set of time delays of the sound from the second UE, the first UE may be configured to measure the set of time delays of the sound from the second UE if the sound is a multi-frequency sound.

At 2110, the first UE may estimate a relative location of the second UE based on the set of phase delays or the set of time delays and the plurality of poses of the first UE, such as described in connection with FIGS. 13A, 13B, 13C, 14, 15 and 16. For example, as discussed in connection with FIG. 16, after the finder device 1302 has collected multiple AoA measurements {θᵢ} of the sound generated from the target device 1304 and also tracking/recording its positions {\vec{pᵢ}} and orientations {Rᵢ} (i.e., its poses) as described in connection with FIG. 15, the finder device 1302 may then compute/calculate what is the most likely position of (or the direction towards) the target device 1304 that is consistent with those measurements. The estimation of the relative location of the second UE may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In one example, as shown at 2102, the first UE may transmit, to the second UE, a request to produce the sound, where measurement of at least one of the set of phase delays or the set of time delays of the sound from the second UE is based on transmission of the request, such as described in connection with FIGS. 13A, 13B, 13C, 14, 15 and 16. For example, as discussed in connection with FIG. 13B, after the process to locate the target device 1304 is initiated, the finder device 1302 may be configured to transmit (e.g., wirelessly) a message to the target device 1304 to start producing sound. Based on the microphone separation (L) of the finder device 1302, the finder device 1302 may request (e.g., using the message) the target device 1304 to choose and produce a sound frequency that meets L<λ/2. For example, the finder device 1302 may indicate the microphone separation (L) to the target device 1304 for the target device 1304 to derive, select, and produce the sound frequency (i.e., the target device 1304 is configured to calculate the sound frequency that meets L<λ/2 based on the given L). In another example, the finder device 1302 may provide a range of frequencies that meets L<λ/2 to the target device 1304, and the target device 1304 may choose and produce a sound frequency from the range of frequencies. In another example, the finder device 1302 may request the target device 1304 to produce the sound with a specific frequency that meets L<λ/2, and the target device 1304 may produce a sound using the specific frequency based on the request. The transmission of the request may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In some implementations, the first UE may further select a wavelength (λ) to be used for the sound based on a distance (L) between the at least two microphones of the first UE, where the distance (L) is less than half of the wavelength (λ) (L<λ/2) and the sound is a pure tone, where the request includes an indication of the wavelength (λ). In some implementations, to measure at least one of the set of phase delays or the set of time delays of the sound from the second UE, the first UE may be configured to measure the set of phase delays of the sound from the second UE.

In some implementations, the request indicates at least one of a range of wavelengths that can be used for the sound or a distance between the at least two microphones of the first UE.

In another example, as shown at 2104, the first UE may detect the second UE is emitting the sound, display an indication of whether to locate the second UE or the sound, and receive, based on the indication, a request to locate the second UE or the sound, where measurement of at least one of the set of phase delays or the set of time delays of the sound from the second UE is based on the request, such as described in connection with FIG. 17. For example, at 1702, the target device 1304 may start producing an alarm sound. At 1704, after the finder device 1302 detects the sound from the target device 1304, the finder device 1302 may identify the sound as an alarm and asks the user whether the user wants to locate the alarm. At 1708, after the finder device 1302 has collected enough position/distance measurements, the finder device 1302 may start providing directional information to the user. The detection of the second UE emitting the sound may be performed by, e.g., the tracking component 198, the plurality of microphones 2240, the transceiver(s) 2222, the one or more sensors 2218, the cellular baseband processor(s) 2224, and/or the application processor(s) 2206 of the apparatus 2204 in FIG. 22.

In some implementations, to measure at least one of the set of phase delays or the set of time delays of the sound from the second UE, the first UE may be configured to measure the set of phase delays of the sound from the second UE.

In another example, as shown at 2106, the first UE may track, while the first UE is moving, at least one of a set of orientations of the first UE or a set of locations of the first UE to obtain the plurality of poses of the first UE, such as described in connection with FIGS. 13A, 13B, 13C, 14, 15 and 16. For example, as discussed in connection with FIG. 15, the finder device 1302 may measure sound AoA from multiple positions/orientations, while recording those positions and orientations (e.g., using information obtained from camera and/or IMU sensors, etc.). The tracking of the set of orientations of the first UE or a set of locations of the first UE may be performed by, e.g., the tracking component 198, the plurality of microphones 2240, the camera 2232, the transceiver(s) 2222, the one or more sensors 2218, the cellular baseband processor(s) 2224, and/or the application processor(s) 2206 of the apparatus 2204 in FIG. 22.

In some implementations, the first UE may further display a request to move the first UE if the first UE is immobile.

In another example, as shown at 2112, the first UE may output an indication of an estimated relative position of the second UE, such as described in connection with FIGS. 17 and 18. For example, as discussed in connection with FIG. 17, at 1708, after the finder device 1302 has collected enough position/distance measurements, the finder device 1302 may start providing directional information to the user (e.g., via UI and/or GUI, etc.). The output of the indication may be performed by, e.g., the tracking component 198, the plurality of microphones 2240, the screen 2210, the transceiver(s) 2222, the one or more sensors 2218, the cellular baseband processor(s) 2224, and/or the application processor(s) 2206 of the apparatus 2204 in FIG. 22.

In some implementations, to output the indication of the estimated relative position of the second UE, the first UE may be configured to transmit the indication of the estimated relative position of the second UE, display the indication of the estimated relative position of the second UE via a screen, or store the indication of the estimated relative position of the second UE.

In another example, as shown at 2114, the first UE may display, via a UI, an estimated relative position of the second UE that includes at least one of: a direction of the second UE from the first UE, a distance of the second UE from the first UE, or an image or a description of the second UE, such as described in connection with FIGS. 17 and 18. For example, as discussed in connection with FIG. 17, at 1708, after the finder device 1302 has collected enough position/distance measurements, the finder device 1302 may start providing directional information to the user (e.g., via UI and/or GUI, etc.). The finder device 1302 may continue to provide updated position/distance information of the target device 1304 as the user gets closer to the target device 1304. The display of the estimated relative position of the second UE may be performed by, e.g., the tracking component 198, the plurality of microphones 2240, the screen 2210, the transceiver(s) 2222, the one or more sensors 2218, the cellular baseband processor(s) 2224, and/or the application processor(s) 2206 of the apparatus 2204 in FIG. 22.

FIG. 22 is a diagram 2200 illustrating an example of a hardware implementation for an apparatus 2204. The apparatus 2204 may be a UE (e.g., a first UE), a component of a UE, or may implement UE functionality. In some aspects, the apparatus 2204 may include at least one cellular baseband processor 2224 (also referred to as a modem) coupled to one or more transceivers 2222 (e.g., cellular RF transceiver). The cellular baseband processor(s) 2224 may include at least one on-chip memory 2224′. In some aspects, the apparatus 2204 may further include one or more subscriber identity modules (SIM) cards 2220 and at least one application processor 2206 coupled to a secure digital (SD) card 2208 and a screen 2210. The application processor(s) 2206 may include on-chip memory 2206′. In some aspects, the apparatus 2204 may further include a plurality of of microphones 2240. In some aspects, the apparatus 2204 may further include a Bluetooth module 2212, a WLAN module 2214, an ultrawide band (UWB) module 2238 (e.g., a UWB transceiver), an SPS module 2216 (e.g., GNSS module), one or more sensors 2218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2226, a power supply 2230, and/or a camera 2232. The Bluetooth module 2212, the UWB module 2238, the WLAN module 2214, and the SPS module 2216 may include an on-chip transceiver (TRX) (or in some cases, just a receiver (RX)). The Bluetooth module 2212, the WLAN module 2214, and the SPS module 2216 may include their own dedicated antennas and/or utilize the antennas 2280 for communication. The cellular baseband processor(s) 2224 communicates through the transceiver(s) 2222 via one or more antennas 2280 with the UE 104 and/or with an RU associated with a network entity 2202. The cellular baseband processor(s) 2224 and the application processor(s) 2206 may each include a computer-readable medium/memory 2224′, 2206′, respectively. The additional memory modules 2226 may also be considered a computer-readable medium/memory. Each computer-readable medium/memory 2224′, 2206′, 2226 may be non-transitory. The cellular baseband processor(s) 2224 and the application processor(s) 2206 are each responsible for general processing, including the execution of software stored on the computer-readable medium/memory. The software, when executed by the cellular baseband processor(s) 2224/application processor(s) 2206, causes the cellular baseband processor(s) 2224/application processor(s) 2206 to perform the various functions described supra. The cellular baseband processor(s) 2224 and the application processor(s) 2206 are configured to perform the various functions described supra based at least in part of the information stored in the memory. That is, the cellular baseband processor(s) 2224 and the application processor(s) 2206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2224/application processor(s) 2206 when executing software. The cellular baseband processor(s) 2224/application processor(s) 2206 may be a component of the UE 350 and may include the at least one memory 360 and/or at least one of the TX processor 368, the RX processor 356, and the controller/processor 359. In one configuration, the apparatus 2204 may be at least one processor chip (modern and/or application) and include just the cellular baseband processor(s) 2224 and/or the application processor(s) 2206, and in another configuration, the apparatus 2204 may be the entire UE (e.g., see UE 350 of FIG. 3) and include the additional modules of the apparatus 2204.

As discussed supra, the tracking component 198 may be configured to measure, from a plurality of poses of the first UE, at least one of a set of phase delays or a set of time delays of sound from a second UE using at least two microphones of the first UE. The tracking component 198 may also be configured to estimate a relative location of the second UE based on the set of phase delays or the set of time delays and the plurality of poses of the first UE. The tracking component 198 may be within the cellular baseband processor(s) 2224, the application processor(s) 2206, or both the cellular baseband processor(s) 2224 and the application processor(s) 2206. The tracking component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2204 may include a variety of components configured for various functions. In one configuration, the apparatus 2204, and in particular the cellular baseband processor(s) 2224 and/or the application processor(s) 2206, may include means for measuring, from a plurality of poses of the first UE, at least one of a set of phase delays or a set of time delays of sound from a second UE using at least two microphones of the first UE. The apparatus 2204 may further include means for estimating a relative location of the second UE based on the set of phase delays or the set of time delays and the plurality of poses of the first UE.

In one configuration, the means for measuring at least one of the set of phase delays or the set of time delays of the sound from the second UE may include configuring the apparatus 2204 to measure the set of time delays of the sound from the second UE if the sound is a multi-frequency sound.

In another configuration, the apparatus 2204 may further include means for transmitting, to the second UE, a request to produce the sound, where measurement of at least one of the set of phase delays or the set of time delays of the sound from the second UE is based on transmission of the request. In some implementations, the apparatus 2204 may further include means for selecting a wavelength (λ) to be used for the sound based on a distance (L) between the at least two microphones of the first UE, where the distance (L) is less than half of the wavelength (λ) (L<λ/2) and the sound is a pure tone, where the request includes an indication of the wavelength (λ). In some implementations, the means for measure at least one of the set of phase delays or the set of time delays of the sound from the second UE may include configuring the apparatus 2204 to measure the set of phase delays of the sound from the second UE. In some implementations, the request indicates at least one of a range of wavelengths that can be used for the sound or a distance between the at least two microphones of the first UE.

In another configuration, the apparatus 2204 may further include means for detecting the second UE is emitting the sound, means for displaying an indication of whether to locate the second UE or the sound, and means for receiving, based on the indication, a request to locate the second UE or the sound, where measurement of at least one of the set of phase delays or the set of time delays of the sound from the second UE is based on the request. In some implementations, the means for measuring at least one of the set of phase delays or the set of time delays of the sound from the second UE may include configuring the apparatus 2204 to measure the set of phase delays of the sound from the second UE.

In another configuration, the apparatus 2204 may further include means for tracking, while the first UE is moving, at least one of a set of orientations of the first UE or a set of locations of the first UE to obtain the plurality of poses of the first UE. In some implementations, the apparatus 2204 may further include means for displaying a request to move the first UE if the first UE is immobile.

In another configuration, the apparatus 2204 may further include means for outputting an indication of an estimated relative position of the second UE. In some implementations, the means for outputting the indication of the estimated relative position of the second UE may include configuring the apparatus 2204 to transmit the indication of the estimated relative position of the second UE, display the indication of the estimated relative position of the second UE via a screen, or store the indication of the estimated relative position of the second UE.

In another configuration, the apparatus 2204 may further include means for displaying, via a UI, an estimated relative position of the second UE that includes at least one of: a direction of the second UE from the first UE, a distance of the second UE from the first UE, or an image or a description of the second UE.

The means may be the tracking component 198 of the apparatus 2204 configured to perform the functions recited by the means. As described supra, the apparatus 2204 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊂F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first user equipment (UE), comprising: measuring, from a plurality of poses of the first UE, at least one of a set of phase delays or a set of time delays of sound from a second UE using at least two microphones of the first UE; and estimating a relative location of the second UE based on the set of phase delays or the set of time delays and the plurality of poses of the first UE.

Aspect 2 is the method of aspect 1, further comprising: transmitting, to the second UE, a request to produce the sound, wherein measurement of at least one of the set of phase delays or the set of time delays of the sound from the second UE is based on transmission of the request.

Aspect 3 is the method of aspect 1 or aspect 2, further comprising: selecting a wavelength (λ) to be used for the sound based on a distance (L) between the at least two microphones of the first UE, wherein the distance (L) is less than half of the wavelength (λ) (L<λ/2) and the sound is a pure tone, wherein the request includes an indication of the wavelength (λ).

Aspect 4 is the method of any of aspects 1 to 3, wherein measuring at least one of the set of phase delays or the set of time delays of the sound from the second UE comprises measuring the set of phase delays of the sound from the second UE.

Aspect 5 is the method of any of aspects 1 to 4, wherein the request indicates at least one of a range of wavelengths that can be used for the sound or a distance between the at least two microphones of the first UE.

Aspect 6 is the method of any of aspects 1 to 5, wherein measuring at least one of the set of phase delays or the set of time delays of the sound from the second UE comprises: measuring the set of time delays of the sound from the second UE if the sound is a multi-frequency sound.

Aspect 7 is the method of any of aspects 1 to 6, further comprising: detecting the second UE is emitting the sound; displaying an indication of whether to locate the second UE or the sound; and receiving, based on the indication, a request to locate the second UE or the sound, wherein measurement of at least one of the set of phase delays or the set of time delays of the sound from the second UE is based on the request.

Aspect 8 is the method of any of aspects 1 to 7, wherein measuring at least one of the set of phase delays or the set of time delays of the sound from the second UE comprises measuring the set of phase delays of the sound from the second UE.

Aspect 9 is the method of any of aspects 1 to 8, further comprising: tracking, while the first UE is moving, at least one of a set of orientations of the first UE or a set of locations of the first UE to obtain the plurality of poses of the first UE.

Aspect 10 is the method of any of aspects 1 to 9, further comprising: displaying a request to move the first UE if the first UE is immobile.

Aspect 11 is the method of any of aspects 1 to 10, wherein estimating the relative location of the second UE based on the set of phase delays or the set of time delays and the plurality of poses of the first UE comprises: computing a set of angle of arrivals (AoAs) of the sound based on the set of phase delays or the set of time delays and the plurality of poses of the first UE; and estimating the relative location of the second UE based on the set of AoAs.

Aspect 12 is the method of any of aspects 1 to 11, further comprising: outputting an indication of an estimated relative position of the second UE.

Aspect 13 is the method of any of aspects 1 to 12, wherein outputting the indication of the estimated relative position of the second UE comprises: transmitting the indication of the estimated relative position of the second UE, displaying the indication of the estimated relative position of the second UE via a screen, or storing the indication of the estimated relative position of the second UE.

Aspect 14 is the method of any of aspects 1 to 13, further comprising: displaying, via a user interface (UI), an estimated relative position of the second UE that includes at least one of: a direction of the second UE from the first UE, a distance of the second UE from the first UE, or an image or a description of the second UE.

Aspect 15 is an apparatus for wireless communication at a first user equipment (UE), including: at least one memory; and at least one processor coupled to the at least one memory and, based at least in part on stored information that is stored in the at least one memory, the at least one processor, individually or in any combination, is configured to implement any of aspects 1 to 14.

Aspect 16 is the apparatus of aspect 15, further including at least one transceiver coupled to the at least one processor.

Aspect 17 is an apparatus for wireless communication at a first user equipment (UE) including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

What is claimed is:

1. An apparatus for wireless communication at a first user equipment (UE), comprising:
at least one memory; and
at least one processor coupled to the at least one memory, wherein the at least one processor is configured to:
measure, from a plurality of poses of the first UE, at least one of a set of phase delays or a set of time delays of sound from a second UE using at least two microphones of the first UE; and
estimate a relative location of the second UE based on the set of phase delays or the set of time delays and the plurality of poses of the first UE.

2. The apparatus of claim 1, wherein the at least one processor is further configured to:
transmit, to the second UE, a request to produce the sound, wherein measurement of at least one of the set of phase delays or the set of time delays of the sound from the second UE is based on transmission of the request.

3. The apparatus of claim 2, wherein the at least one processor is further configured to:
select a wavelength (λ) to be used for the sound based on a distance (L) between the at least two microphones of the first UE, wherein the distance (L) is less than half of the wavelength (λ) (L<λ/2) and the sound is a pure tone, wherein the request includes an indication of the wavelength (λ).

4. The apparatus of claim 3, wherein to measure at least one of the set of phase delays or the set of time delays of the sound from the second UE, the at least one processor is configured to measure the set of phase delays of the sound from the second UE.

5. The apparatus of claim 2, wherein the request indicates at least one of a range of wavelengths that can be used for the sound or a distance between the at least two microphones of the first UE.

6. The apparatus of claim 1, wherein to measure at least one of the set of phase delays or the set of time delays of the sound from the second UE, the at least one processor is configured to:
measure the set of time delays of the sound from the second UE if the sound is a multi-frequency sound.

7. The apparatus of claim 1, wherein the at least one processor is further configured to:
detect the second UE is emitting the sound;
display an indication of whether to locate the second UE or the sound; and
receive, based on the indication, a request to locate the second UE or the sound, wherein measurement of at least one of the set of phase delays or the set of time delays of the sound from the second UE is based on the request.

8. The apparatus of claim 7, wherein to measure at least one of the set of phase delays or the set of time delays of the sound from the second UE, the at least one processor is configured to measuring the set of phase delays of the sound from the second UE.

9. The apparatus of claim 1, wherein the at least one processor is further configured to:
track, while the first UE is moving, at least one of a set of orientations of the first UE or a set of locations of the first UE to obtain the plurality of poses of the first UE.

10. The apparatus of claim 9, wherein the at least one processor is further configured to:
display a request to move the first UE if the first UE is immobile.

11. The apparatus of claim 1, wherein to estimate the relative location of the second UE based on the set of phase delays or the set of time delays and the plurality of poses of the first UE, the at least one processor is configured to:
compute a set of angle of arrivals (AoAs) of the sound based on the set of phase delays or the set of time delays and the plurality of poses of the first UE; and
estimate the relative location of the second UE based on the set of AoAs.

12. The apparatus of claim 1, wherein the at least one processor is further configured to:
output an indication of an estimated relative position of the second UE.

13. The apparatus of claim 12, wherein to output the indication of the estimated relative position of the second UE, the at least one processor is configured to:
transmit the indication of the estimated relative position of the second UE,
display the indication of the estimated relative position of the second UE via a screen, or
store the indication of the estimated relative position of the second UE.

14. The apparatus of claim 1, wherein the at least one processor is further configured to:
display, via a user interface (UI), an estimated relative position of the second UE that includes at least one of:
a direction of the second UE from the first UE,
a distance of the second UE from the first UE, or
an image or a description of the second UE.

15. A method of wireless communication at a first user equipment (UE), comprising:
measuring, from a plurality of poses of the first UE, at least one of a set of phase delays or a set of time delays of sound from a second UE using at least two microphones of the first UE; and
estimating a relative location of the second UE based on the set of phase delays or the set of time delays and the plurality of poses of the first UE.

16. The method of claim 15, further comprising:
transmitting, to the second UE, a request to produce the sound, wherein measurement of at least one of the set of phase delays or the set of time delays of the sound from the second UE is based on transmission of the request.

17. The method of claim 16, further comprising:
selecting a wavelength (λ) to be used for the sound based on a distance (L) between the at least two microphones of the first UE, wherein the distance (L) is less than half of the wavelength (λ) (L<λ/2) and the sound is a pure tone, wherein the request includes an indication of the wavelength (λ).

18. The method of claim 16, wherein the request indicates at least one of a range of wavelengths that can be used for the sound or a distance between the at least two microphones of the first UE.

19. The method of claim 15, further comprising:
tracking, while the first UE is moving, at least one of a set of orientations of the first UE or a set of locations of the first UE to obtain the plurality of poses of the first UE; and
displaying a request to move the first UE if the first UE is immobile.

20. An apparatus for wireless communication at a first user equipment (UE), comprising:
a user interface (UI);
at least one memory; and
at least one processor coupled to the at least one memory, wherein the at least one processor is configured to:
provide, at the UI, a guidance for moving the first UE if the first UE is immobile;
measure, from a plurality of poses of the first UE, at least one of a set of phase delays or a set of time delays of sound from a second UE using at least two microphones of the first UE;
estimate a relative position of the second UE based on the set of phase delays or the set of time delays and the plurality of poses of the first UE; and
display, via the UI, the relative position of the second UE that includes at least one of:
a direction of the second UE from the first UE,
a distance of the second UE from the first UE, or
an image or a description of the second UE.
